(19) United States
(12) Patent Application Publication
(10) Pub. No.: US 2026/0195005 A1
(43) Pub. Date: Jul. 9, 2026

(54) APPARATUS AND METHOD FOR SENSING TOUCH

(71) Applicant: LX SEMICON CO., LTD., Daejeon (KR)

(72) Inventors: Youn Ho JUNG, Daejeon (KR); Yeong Il JEON, Daejeon (KR)

(73) Assignee: LX SEMICON CO., LTD., Daejeon (KR)

(21) Appl. No.: 19/133,056

(22) PCT Filed: Oct. 31, 2023
(86) PCT No.: PCT/KR2023/017107

§ 371 Date: May 27, 2025

(30) Foreign Application Priority Data
Nov. 25, 2022 (KR) 10-2022-0160486
Oct. 18, 2023 (KR) 10-2023-0139169

(51) Int. Cl. G06F 3/041; G06F 3/044

(52) U.S. Cl. CPC G06F 3/0416; G06F 3/0446

(57) ABSTRACT

The present disclosure relates to a touch sensing apparatus and method capable of efficiently and quickly processing a big touch with a large touch area by a plurality of touch ICs in response to an occurrence of the big touch on a touch panel, the touch sensing apparatus includes a first touch IC configured to generate first touch data corresponding to a first region of the touch panel, and a second touch IC configured to generate second touch data corresponding to a second region adjacent to the first region of the touch panel, wherein the second touch IC may check whether there is a touch on a boundary surface of the second region adjacent to the first region based on a touch sensing signal when the touch sensing signal is input from a touch sensor positioned in the second region of the touch panel, check whether the touch is a big touch of a preset size or more when there is the touch on the boundary surface, separate a boundary touch region adjacent to the boundary surface out of an entire region of the big touch when the touch is a big touch, and transmit boundary touch information of the separated boundary touch region to the first touch IC.

### TECHNICAL FIELD

The present disclosure relates to a touch sensing apparatus including a plurality of touch integrated circuits (ICs) In addition, more specifically, to a touch sensing apparatus and method capable of efficiently and quickly processing a big touch with a large touch area by a plurality of touch ICs in response to an occurrence of the big touch on a touch panel.

### BACKGROUND

In general, touch-sensing technology is a technology for recognizing a user's input operation by sensing a signal that is generated when an object is close to or is in contact with a touch panel including a sensor.

Various types such as a magnetic type, a resistive type, and a capacitive type are used in the touch-sensing technology, but the capacitive type has become popular in recent years.

A plurality of sensors are disposed in the touch panel, and the wider an area of the touch panel or the higher a resolution of the touch panel, more sensors may be disposed in the touch panel.

Recently, as the area of the touch panel is getting larger and the resolution of the touch panel is getting higher simultaneously, a number of sensors disposed in the touch panel is also increasing.

When the number of the sensors disposed in the touch panel is increased, sensing signals may be distributed to process the sensing signal using a plurality of touch integrated circuits (ICs), rather than processing all sensing signals using one touch IC.

As an example, a first touch IC among a plurality of touch ICs may process a sensing signal for a first region of the touch panel, and a second touch IC may process a sensing signal for a second region of the touch panel.

However, when a big touch with a large touch area on the touch panel occurs in a boundary region including a part of the first region and a part of the second region of the touch panel, the first touch IC may not determine accurately whether the touch of the touch panel is one single touch or a plurality of multi-touches, and thus there was a problem with inaccurate touch sensing.

In addition, when the first touch IC processes all of the touch regions corresponding to the big touch, there was also a problem that a touch processing speed decreases significantly due to an increase in communication time for receiving touch sensing data for the second region of the touch panel from the second touch IC.

Therefore, it is necessary to develop a touch sensing apparatus capable of accurately recognizing the big touch of the touch panel and processing the big touch efficiently and quickly in the future.

### SUMMARY

### Technical Problem

The present disclosure is directed to solving the above-described problems and other problems.

The present disclosure is directed to providing a touch sensing apparatus and method capable of accurately recognizing a big touch of a touch panel and processing the big touch efficiently and quickly by transmitting only necessary information of a boundary touch region out of an entire region of a big touch to an adjacent touch IC when a boundary touch between different regions of the touch panel is the big touch.

### Technical Solution

A touch sensing apparatus according to an embodiment of the present disclosure is a touch sensing apparatus configured to process a touch on a touch panel, the touch sensing apparatus includes a first touch IC configured to generate first touch data corresponding to a first region of the touch panel, and a second touch IC configured to generate second touch data corresponding to a second region adjacent to the first region of the touch panel, wherein the second touch IC may check whether there is a touch on a boundary surface of the second region adjacent to the first region based on a touch sensing signal when the touch sensing signal is input from a touch sensor positioned in the second region of the touch panel, check whether the touch is a big touch of a preset size or more when there is the touch on the boundary surface, separate a boundary touch region adjacent to the boundary surface out of an entire region of the big touch when the touch is a big touch, and transmit boundary touch information of the separated boundary touch region to the first touch IC.

A touch IC of a touch sensing apparatus according to another embodiment of the present disclosure is a touch IC connected to touch sensors corresponding to one region of a touch panel, the touch IC includes a communication unit connected to communication with another touch IC connected to touch sensors corresponding to another region of the touch panel, and a touch data processing unit configured to generate touch data for the one region of the touch panel, wherein the touch data processing unit may check whether there is a touch on a boundary surface of the one region adjacent to the another region based on a touch sensing signal when the touch sensing signal is input from the touch sensor positioned in the one region of the touch panel, check whether the touch is a big touch larger than a preset size when there is the touch on the boundary surface, separate a boundary touch region adjacent to the boundary surface out of an entire region of the big touch when the touch is the big touch, and transmit boundary touch information of the separated boundary touch region to the another touch IC.

A touch sensing method according to an embodiment of the present disclosure is a touch sensing method of a touch sensing apparatus including a first touch IC configured to generate first touch data corresponding to a first region of a touch panel and a second touch IC configured to generate second touch data corresponding to a second region of the touch panel adjacent to the first region, the touch sensing method may include checking, by the second touch IC, whether there is a touch on a boundary surface of the second region adjacent to the first region based on a touch sensing signal when the touch sensing signal is input from a touch sensor in the second region of the touch panel, checking, by the second touch IC, whether the touch is a big touch of a preset size or more when there is the touch on the boundary surface, separating, by the second touch IC, a boundary touch region adjacent to the boundary surface out of an entire region of the big touch when the touch is a big touch, and transmitting, by the second touch IC, boundary touch information of the separated boundary touch region to the first touch IC.

### Advantageous Effects

According to an embodiment of the present disclosure, a touch sensing apparatus can accurately recognize a big touch of a touch panel and process the big touch efficiently and quickly by transmitting only necessary information of a boundary touch region out of an entire region of a big touch to an adjacent touch IC when a boundary surface touch between different regions of a touch panel is the big touch.

That is, in the present disclosure, when the boundary surface touch is the big touch, if finger separation of the big touch is possible, only touch information of a part of a separable boundary surface out of the entire region of the big touch is transmitted to the adjacent touch IC or if the finger separation of the big touch is not possible, only some of the touch information excluding touch sensing data out of total touch information of the big touch is transmitted to the adjacent touch IC, thereby processing the big touch efficiently and quickly by minimizing a transmission amount and a transmission time of touch information.

### BRIEF DESCRIPTION OF THE DRAWINGS

FIG. 1 is a diagram for describing a display device according to an embodiment of the present disclosure;

FIG. 2 is a diagram for describing a touch sensing apparatus of a display device according to an embodiment of the present disclosure;

FIGS. 3 to 8 are diagrams for describing operations corresponding to touch positions of a touch sensing apparatus according to an embodiment of the present disclosure;

FIGS. 9 to 11 are diagrams for describing touch information transmitted between touch ICs;

FIGS. 12 to 14 are diagrams for describing an operation of a touch region separation method of a touch sensing apparatus according to an embodiment of the present disclosure;

FIG. 15 is a diagram for describing a touch IC of a touch sensing apparatus according to an embodiment of the present disclosure;

FIGS. 16 to 18 are diagrams for describing a connection relationship between a touch panel and a touch IC according to an embodiment of the present disclosure; and

FIGS. 19 to 21 are diagrams for describing a touch sensing method of a touch sensing apparatus according to an embodiment of the present disclosure.

### DETAILED DESCRIPTION OF THE EMBODIMENTS

Hereinafter, the embodiment disclosed in the present specification will be described in detail with reference to the accompanying drawings, but the same or similar components are designated by the same reference numerals regardless of drawing numbers, and repeated description thereof will be omitted. The component suffixes “module” and “part” used in the following description are given or mixed together only considering the ease of creating the specification, and have no meanings or roles that are distinguished from each other by themselves. In addition, in describing the embodiments disclosed in the present specification, when it is determined that detailed descriptions of a related well-known art unnecessarily obscure gist of the embodiments disclosed in the present specification, the detailed description thereof will be omitted. Further, the accompanying drawings are merely for facilitating understanding of the embodiments disclosed in the present specification, the technological scope disclosed in the present specification is not limited by the accompanying drawings, and it should be understood as including all modifications, equivalents and alternatives that fall within the spirit and scope of the present disclosure.

Terms including ordinal numbers, such as first, second, etc., may be used to describe various components, but the components are not limited by the terms. The terms are only used to distinguish one component from another.

It will be understood that when a component is referred to as being “connected” or “coupled” to another component, it may be directly connected or coupled to the other component, but intervening components may be present therebetween. In contrast, it should be understood that when a component is referred to as being “directly connected” or “directly coupled” to another component, there are no other intervening components present.

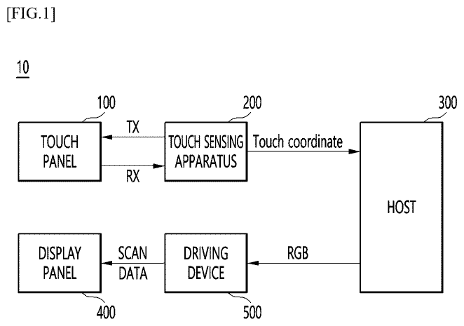

FIG. 1 is a diagram for describing a display device according to an embodiment of the present disclosure.

As shown in FIG. 1, a display device 10 may include a display panel 400 and a touch panel 100.

Here, the display device 10 may be configured as a separate panel in which the display panel 400 and the touch panel 100 are separated from each other.

In some cases, the display device 10 may be configured as an integrated panel in which the display panel 400 and the touch panel 100 are coupled to each other.

As an example, the display device 10 may be an integrated panel and include an in-cell type panel (not shown). The in-cell type panel may use a display electrode or a touch electrode as a common electrode.

In addition, the display device 10 may include a driving device 500 for driving the display panel 400 and a touch sensing apparatus 200 for driving the touch panel 100 and sensing a touch.

In addition, the display device 10 may include a host 300 capable of transmitting display information to the driving device 500 and receiving touch information from the touch sensing apparatus 200.

Here, in the display device 10, the driving device 500 and the touch sensing apparatus 200 may be disposed separately but may be disposed in one integrated circuit device.

When the display device 10 includes the integrated panel in which the display panel 400 and the touch panel 100 are coupled to each other, it may be advantageous that the driving device 500 and the touch sensing apparatus 200 are configured as one integrated circuit device.

As an example, since the in-cell type panel uses the display electrode or the touch electrode as the common electrode, when the driving device 500 and the touch sensing apparatus 200 are integrated and disposed in one integrated circuit device, the common electrode may be driven as the display electrode and the common electrode may be driven as the touch electrode by using one driving circuit.

In addition, the display panel 400 may include at least one of a liquid crystal display (LCD), a thin film transistor-liquid crystal display (TFT LCD), an organic light-emitting diode (OLED), a flexible display, and a 3D display.

Some of such display panels 400 may be transparent or light-transmissive such that the outside may be viewed through them.

It may be referred to as a transparent display module, and a representative example of the transparent display module include a transparent OLED (TOLED).

The display panel 400 may include a plurality of data lines, a plurality of gate lines intersecting the data lines, a plurality of thin film transistors (TFTs) formed at intersections of the data lines and the gate lines, a plurality of display electrodes for charging a data voltage in the cells, and a storage capacitor connected to the display electrodes to maintain the voltage of the cell.

Next, the driving device 500 may convert digital video data (RGB) input from the host 300 or a timing controller (not shown) into analog positive polarity/negative polarity gamma compensation voltage to output a data voltage (DATA).

Here, the data voltage may be supplied to the data lines.

The driving device 500 may sequentially supply gate pulses (SCAN) to the gate lines of the display panel 400 to select a gate line to which the data voltage (DATA) is applied.

As such, the display panel 400 and the driving device 500 may perform a function of displaying an image on a screen of the display device 10.

Next, the display device 10 may sense a user manipulation through the touch panel 100 and the touch sensing apparatus 200.

Here, the touch panel 100 may be separately disposed above the display panel 400.

In some cases, the touch panel 100 may be disposed on the same substrate as a pixel array of the display panel 400 to be formed of an in-cell type.

In addition, the touch panel 100 may include a plurality of driving electrodes, a plurality of receiving electrodes, and a plurality of touch sensors.

Here, the driving electrodes and the receiving electrodes may have a cross structure in which they are positioned on different layers and are disposed to cross each other.

In such a cross structure, the sensors may be capacitors formed at intersections of the driving electrodes and the receiving electrodes.

In some cases, the driving electrodes and the receiving electrodes may be positioned on the same layer to have a one-layer structure.

In such a one-layer structure, the sensors may be capacitors formed horizontally between the driving electrodes and the receiving electrodes.

As another case, the driving electrode and the receiving electrode may have a self-structure.

In such a self-structure, the sensors may be capacitors formed between the receiving electrodes and peripheral electrodes.

As such, the driving electrodes and receiving electrodes of the touch panel 100 may have various positional relationships.

Here, the capacitor positioned between the receiving electrodes and the peripheral electrodes or between the receiving electrodes may function as the touch sensor.

That is, a capacitance of the capacitor is changed by an object being close to or being in contact with the touch panel 100, thereby sensing a touch.

Next, the touch sensing apparatus 200 may provide a driving signal TX to the driving electrodes, generate a touch coordinate by sensing a sensing signal RX of the touch sensor through the receiving electrodes, and transmit such touch coordinate data to the host 300.

Here, the touch sensing apparatus 200 may include two or more touch ICs and distribute and process a sensing signal using two or more touch ICs.

Each of the touch ICs of the touch sensing apparatus 200 may be responsible for touch sensing corresponding to a partial region of the touch panel 100.

As an example, when the touch panel 100 is divided into two regions, the touch sensing apparatus 200 may sense a touch signal corresponding to each divided region using two touch ICs.

As another example, when the touch panel 100 is divided into three regions, the touch sensing apparatus 200 may sense a touch signal corresponding to each divided region using three touch ICs.

In addition, each touch IC may include one or more read-out integrated circuits (ROICs) configured to supply a touch driving signal to the touch panel 100 and receive a touch sensing signal from the touch panel 100 and a micro controller unit (MCU) configured to determine the presence or position of a big touch of a touch input using touch sensing signal detection results.

Here, one or more ROICs may be implemented as individual components or as one integrated component.

In some cases, each touch IC may include only ROIC and may be implemented such that one MCU is separated to be commonly connected to a plurality of touch ICs.

Here, the MCU may determine whether there is a big touch based on the touch sensing signal received from the ROIC.

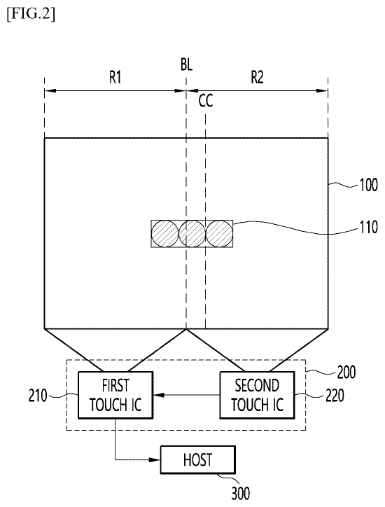

FIG. 2 is a diagram for describing a touch sensing apparatus of a display device according to an embodiment of the present disclosure.

As shown in FIG. 2, the touch sensing apparatus 200 may include a first touch IC 210 configured to generate first touch data corresponding to a first region R1 of a touch panel 100 and a second touch IC 220 configured to generate second touch data corresponding to a second region R2 adjacent to the first region R1 of the touch panel 100.

In some cases, the present disclosure may further include a third touch IC configured to generate third touch data corresponding to a third region adjacent to the second region R2 of the touch panel 100 when the touch panel 100 is divided into three regions.

As an example, a number of touch ICs may be equal to a number of divided regions of the touch panel 100.

When the touch sensing signal is input from a touch sensor positioned in the first region R1 of the touch panel 100, the first touch IC 210 may process the first touch data of the first region R1 based on the touch sensing signal, and when receiving boundary touch information of a boundary touch region from the second touch IC 220, the first touch IC 210 may process the third touch data of the boundary touch region within the second region R2 based on the boundary touch information.

Here, the boundary touch region may be a region between the boundary line BL between the first region R1 and the second region R2 and a preset reference column CC and include a peripheral region of a boundary line within the second region.

The first touch IC 210 may process the first touch data of the first region R1 and simultaneously receive the boundary touch information of the boundary touch region within the second region R2 from the second touch IC 220.

In addition, when receiving the boundary touch information from the second touch IC 220, the first touch IC 210 may process continuously the third touch data of the boundary touch region within the second region R2 based on the boundary touch information after processing the first touch data of the first region R1.

In addition, after receiving the boundary touch information from the second touch IC 220, the first touch IC 210 may check whether there is a touch 110 on the boundary surface of the first region R1 adjacent to the second region R2 and check whether the boundary touch region adjacent to the boundary surface of the first region R1 out of an entire region of the touch 110 is separable.

As an example, the first touch IC 210 may wait until all boundary touch information has been received from the second touch IC 220, check whether the boundary touch region within the first region R1 is separable when all boundary touch information has been received from the second touch IC 220, process the first touch data of the boundary touch region within the first region R1 when the boundary touch region within the first region R1 is separable, and process the third touch data of the boundary touch region within the second region R2 based on the boundary touch information that has been received continuously.

Here, when checking whether the boundary touch region within the first region R1 is separable, the first touch IC 210 may acquire touch sensitivity of the entire touch region of the first region R1 based on the touch sensing signal, acquire touch sensitivity of the boundary touch region within the second region R2 from the boundary touch information received from the second touch IC 220, search for touch sensors whose touch sensitivity is a reference value or more based on the acquired touch sensitivity, and analyze the touch sensitivity of touch sensors positioned between the touch sensors whose touch sensitivity is the reference value or more to check whether the boundary touch region within the first region R1 is separable.

As an embodiment, when the touch sensitivity of touch sensors positioned between the touch sensors whose touch sensitivity is the reference value or more gradually decreases and then increases, the first touch IC 210 may check that the boundary touch region is separable around the touch sensor with the lowest level of touch sensitivity.

Here, when touch sensitivity of a touch sensor positioned at an X coordinate among the touch sensors positioned between the touch sensors whose touch sensitivity is the reference value or more gradually decreases and then increases, the first touch IC 210 may check that the boundary touch region is separable around the touch sensor with the lowest level of touch sensitivity.

In some cases, when touch sensitivity of a touch sensor positioned at a Y coordinate among touch sensors positioned between touch sensors whose touch sensitivity is the reference value or more gradually decreases and then increases, the first touch IC 210 may also check that the boundary touch region is separable around the touch sensor with the lowest level of touch sensitivity.

As another case, when the touch sensitivity of the touch sensor positioned at the X coordinate and the touch sensitivity of the touch sensor positioned at the Y coordinate among touch sensors positioned between touch sensors whose touch sensitivity is the reference value or more gradually decrease and then increase, the first touch IC 210 may also check that the boundary touch region is separable around the touch sensor with the lowest level of touch sensitivity.

As still another case, when the touch sensitivity gradually decreases and then increases, the first touch IC 210 may recognize a touch means as a finger and determine that finger separation is possible.

As another embodiment, the first touch IC 210 may input the touch sensitivity of the touch sensors positioned between the touch sensors whose touch sensitivity is the reference value or more into a pre-trained neural network model to predict a touch sensor of separation reference based on a touch sensitivity level distribution.

As still another embodiment, when touch sensitivity of touch sensors positioned within a certain distance from touch sensors whose touch sensitivity is the reference value or more have a preset sensitivity level distribution, the first touch IC 210 may select a touch sensor that becomes a separation reference based on the preset sensitivity level distribution and check that the boundary touch region is separable around the selected touch sensor.

Here, the first touch IC 210 may input the touch sensitivity of the touch sensors positioned within the certain distance from the touch sensors whose touch sensitivity is the reference value or more into a pre-trained neural network model to predict the touch sensor of the separation reference based on the touch sensitivity level distribution.

Next, when the first touch IC 210 is selected as a master IC, the first touch IC 210 may receive the second touch data of the second region R2 from the second touch IC 220, generate big touch information based on the first touch data of the first region R1, the second touch data of the second region R2, and the third touch data of the boundary touch region within the second region R2, and transmit the generated big touch information to the host 300.

Here, the first touch IC 210 may check whether the first touch IC 210 has been pre-selected as the master IC after processing the first touch data of the first region R1 and the third touch data of the boundary touch region within the second region R2 and request the second touch IC to transmit the second touch data of the second region R2 when the first touch IC 210 is pre-selected as the master IC.

In this case, the first touch IC 210 may check through pre-stored user setting information or through a user input requesting selection as the master IC when checking whether the first touch IC 210 has been pre-selected as the master IC.

In addition, when generating big touch information, the first touch IC 210 may generate big touch information including big touch coordinate information, big touch sensitivity information, and a number of big touch sensors.

Further, when generating big touch information, the first touch IC 210 may further generate the big touch information including the big touch coordinate information, the big touch sensitivity information, and the number of big touch sensors, overall touch size information, and information on a number of touch sensors of a boundary surface around a boundary line BL.

As an example, the touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of big touch sensors may include a total number of touch sensors within the big touch region covered by the big touch.

In some cases, when generating big touch information, the first touch IC 210 may generate touch tracking information based on the first touch data of the first region R1, the second touch data of the second region R2, and the third touch data of the boundary touch region within the second region R2 and transmit the touch tracking information together with the big touch information to the host 300.

Here, the touch tracking information may include information linking a touch coordinate generated in a previous frame with a touch coordinate generated in a current frame and include information capable of sensing a continuous touch operation like a sliding touch.

In addition, the first touch IC 210 may receive boundary touch information including touch coordinate information, touch sensitivity information, and a number of touch sensors of the boundary touch region from the second touch IC 220.

As an example, when receiving boundary touch information, the first touch IC 210 may receive boundary touch information including touch sensing data corresponding to all touch sensors positioned within the boundary touch region.

Here, when receiving the boundary touch information including the touch sensing data, if it is determined that a touch of the second region R2 is not a big touch of a preset size or more or the big touch is separable, the first touch IC 210 may receive the boundary touch information including the touch sensing data from the second touch IC 220.

As another example, when receiving boundary touch information, the first touch IC 210 may receive boundary touch information not including touch sensing data corresponding to each touch sensor in the boundary touch region.

Here, when receiving the boundary touch information not including the touch sensing data, if it is determined that the touch of the second region R2 is a big touch of the preset size or more and the big touch is not separable, the first touch IC 210 may receive boundary touch information not including touch sensing data from the second touch IC 220.

For example, the touch coordinate information may include the X end touch sensor coordinate, the Y start touch sensor coordinate, and the Y end touch sensor coordinate, the big touch sensitivity information may include a maximum sensitivity value of the touch sensor, the X coordinate touch sensor position with maximum sensitivity, and the Y coordinate touch sensor position with maximum sensitivity, and the number of touch sensors may include a total number of touch sensors in the boundary touch region covered by the touch.

Meanwhile, the second touch IC 220 may check whether there is the touch 110 at a boundary surface of the second region R2 adjacent to the first region R1 based on a touch sensing signal when the touch sensing signal is input from a touch sensor positioned in the second region R2 of the touch panel 100, check whether the touch 110 is the big touch of the preset size or more when there is the touch 110 at the boundary surface, separate a boundary touch region adjacent to the boundary surface out of an entire region of the big touch when the touch is a big touch, and transmit boundary touch information of the separated boundary touch region to the first touch IC 210.

Here, when the touch sensing signal is input from the touch sensor positioned in the second region R2 of the touch panel 100 before checking whether there is the touch 110 at the boundary surface adjacent to the first region R1, the second touch IC 220 may check whether the first touch IC 210 configured to generate the first touch data corresponding to the first region R1 of the touch panel 100 exists and check there is the touch 110 at the boundary surface adjacent to the first region R1 when the first touch IC 210 exists.

In this case, when the first touch IC 210 is not present, the second touch IC 220 may check whether there is the touch 110 in the second region R2 based on the touch sensing signal, check whether a partial touch region out of an entire region of the touch 110 is separable, process touch data of the separated partial touch region when a partial touch region within the second region R2 is separable, and then sequentially process touch data of a remaining touch region.

In addition, when checking whether the partial touch region is separable, the second touch IC 220 may acquire touch sensitivity of the entire touch region of the second region R2 based on the touch sensing signal, search for touch sensors whose touch sensitivity is the reference value or more based on the acquired touch sensitivity, and analyze the touch sensitivity of touch sensors positioned between the touch sensors whose touch sensitivity is the reference value or more to check whether the partial touch region within the second region R2 is separable.

Here, when the touch sensitivity of touch sensors positioned between the touch sensors whose touch sensitivity is the reference value or more gradually decreases and then increases, the second touch IC 220 may check that the partial touch region is separable around the touch sensor with the lowest level of touch sensitivity.

As an example, when touch sensitivity of a touch sensor positioned at an X coordinate among the touch sensors positioned between the touch sensors whose touch sensitivity is the reference value or more gradually decreases and then increases, the second touch IC 220 may check that the partial touch region is separable around the touch sensor with the lowest level of touch sensitivity.

As another example, when touch sensitivity of a touch sensor positioned at a Y coordinate among touch sensors positioned between touch sensors whose touch sensitivity is the reference value or more gradually decreases and then increases, the second touch IC 220 may also check that the partial touch region is separable around the touch sensor with the lowest level of touch sensitivity.

As still another example, when the touch sensitivity of the touch sensor positioned at the X coordinate and the touch sensitivity of the touch sensor positioned at the Y coordinate among touch sensors positioned between touch sensors whose touch sensitivity is the reference value or more gradually decrease and then increase, the second touch IC 220 may also check that the partial touch region is separable around the touch sensor with the lowest level of touch sensitivity.

As still another example, when the touch sensitivity gradually decreases and then increases, the second touch IC 220 may recognize a touch means as a finger and determine that finger separation is possible.

In some cases, the second touch IC 220 may input the touch sensitivity of the touch sensors positioned between the touch sensors whose touch sensitivity is the reference value or more into a pre-trained neural network model to predict a touch sensor of separation reference based on a touch sensitivity level distribution.

As another case, when touch sensitivity of touch sensors positioned within a certain distance from touch sensors whose touch sensitivity is the reference value or more have a preset sensitivity level distribution, the second touch IC 220 may select a touch sensor that becomes a separation reference based on the preset sensitivity level distribution and check that the partial touch region is separable around the selected touch sensor.

Here, the second touch IC 220 may input the touch sensitivity of the touch sensors positioned within the certain distance from the touch sensors whose touch sensitivity is the reference value or more into a pre-trained neural network model to predict the touch sensor of the separation reference based on the touch sensitivity level distribution.

In addition, the second touch IC 220 may recognize that there is a touch on the boundary surface adjacent to the first region R1 when a touch sensing signal is input from at least one of touch sensors arranged in a first column of the second region R2 with respect to the boundary line BL when checking whether there is a touch on the boundary surface adjacent to the first region R1.

In some cases, when a touch sensing signal is not input from the touch sensors arranged in the first column of the second region R2 with respect to the boundary line BL, the second touch IC 220 may recognize that there is no touch on the boundary surface adjacent to the first region R1.

Here, the second touch IC 220 may check that touch sensing signals are input from touch sensors arranged in columns other than the first column of the second region R2 when there is no touch on the boundary surface adjacent to the first region R1 and process the second touch data in the second region R2 based on touch sensing signals when the touch sensing signals are input from touch sensors arranged in other columns.

In addition, when the second touch IC 220 may store the processed second touch data in a memory when processing the second touch data of the second region R2 and transmit the stored second touch data to the first touch IC 210 when receiving a transmission request of the second touch data from the first touch IC 210 which is pre-selected as the master IC.

As another embodiment, when processing the second touch data of the second region R2, the second touch IC 220 may store the processed second touch data in the memory, receive the first touch data of the first region R1 from the first touch IC 210 when the second touch IC 220 is selected as the master IC, generate touch information based on the first touch data of the first region R1 and the second touch data of the second region R2, and transmit the generated touch information to the host 300.

Here, the second touch IC 220 may check whether the second touch IC 220 has been pre-selected as the master IC after processing the second touch data of the second region R2 and request the first touch IC 210 to transmit the first touch data of the first region R1 when the second touch IC 220 is pre-selected as the master IC.

As an example, the second touch IC 220 may check through pre-stored user setting information or through a user input requesting selection as the master IC when checking whether the second touch IC 220 has been pre-selected as the master IC.

In addition, when generating touch information, the second touch IC 220 may generate touch information including touch coordinate information, touch sensitivity information, and a number of touch sensors.

In some cases, when generating touch information, the second touch IC 220 may also generate touch information including touch sensing data corresponding to all touch sensors positioned within the touch region.

Here, the touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

In addition, when generating touch information, the second touch IC 220 may generate touch tracking information based on the first touch data in the first region R1 and the second touch data in the second region R2 and transmit the touch tracking information together with the touch information to the host 300.

Next, the second touch IC 220 may check whether the touch 110 is continuous from a touch sensor arranged in a first column of the second region R2 with respect to the boundary line BL to a touch sensor arranged in an Nth reference column CC and recognize the touch as the big touch of the preset size or more when the touch 110 is continuous when checking whether the touch 110 is the big touch of the preset size or more.

In some cases, when the touch 110 is continuous from the touch sensor arranged in the first column of the second region R2 with respect to the boundary line BL to a touch sensor arranged in an N−1th column at the boundary surface, the second touch IC 220 may recognize the touch as a normal touch smaller than the big touch.

Here, when recognizing the touch 110 as the normal touch, the second touch IC 220 may transmit the boundary touch information of the boundary touch region adjacent to the boundary to the first touch IC 210.

In addition, when transmitting the boundary touch information, the second touch IC 220 may transmit touch coordinate information, touch sensitivity information, a number of touch sensors of the boundary touch region, and boundary touch information including touch sensing data corresponding to all touch sensors positioned within the boundary touch region to the first touch IC 210.

Next, when separating the boundary touch region adjacent to the boundary surface, the second touch IC 220 may check whether the boundary touch region adjacent to the boundary line BL out of the entire region of the big touch is separable, and when the boundary touch region is separable, the second touch IC may separate the boundary touch region of the big touch and transmit the boundary touch information of the separated boundary touch region to the first touch IC 210.

Here, when checking whether the boundary touch region of the big touch is separable, the second touch IC 220 may acquire touch sensitivity of the entire big touch region of the second region R2 based on the touch sensing signal, search for touch sensors whose touch sensitivity is the reference value or more based on the acquired touch sensitivity, and analyze the touch sensitivity of touch sensors positioned between the touch sensors whose touch sensitivity is the reference value or more to check whether the boundary touch region of the big touch is separable.

In this case, when the touch sensitivity of touch sensors positioned between the touch sensors whose touch sensitivity is the reference value or more gradually decreases and then increases, the second touch IC 220 may check that the boundary touch region is separable around the touch sensor with the lowest level of touch sensitivity.

As an example, when touch sensitivity of a touch sensor positioned at an X coordinate among the touch sensors positioned between the touch sensors whose touch sensitivity is the reference value or more gradually decreases and then increases, the second touch IC 220 may check that the boundary touch region is separable around the touch sensor with the lowest level of touch sensitivity.

As another example, when touch sensitivity of a touch sensor positioned at a Y coordinate among touch sensors positioned between touch sensors whose touch sensitivity is the reference value or more gradually decreases and then increases, the second touch IC 220 may check that the boundary touch region is separable around the touch sensor with the lowest level of touch sensitivity.

As still another example, when the touch sensitivity of the touch sensor positioned at the X coordinate and the touch sensitivity of the touch sensor positioned at the Y coordinate among touch sensors positioned between touch sensors whose touch sensitivity is the reference value or more gradually decrease and then increase, the second touch IC 220 may check that the boundary touch region is separable around the touch sensor with the lowest level of touch sensitivity.

As still another example, when the touch sensitivity gradually decreases and then increases, the second touch IC 220 may recognize a touch means as a finger and determine that finger separation is possible.

In some cases, the second touch IC 220 may input the touch sensitivity of the touch sensors positioned between the touch sensors whose touch sensitivity is the reference value or more into a pre-trained neural network model to predict a touch sensor of separation reference based on a touch sensitivity level distribution.

In another case, when touch sensitivity of touch sensors positioned within a certain distance from touch sensors whose touch sensitivity is the reference value or more have a preset sensitivity level distribution, the second touch IC 220 may select a touch sensor that becomes a separation reference based on the preset sensitivity level distribution and check that the boundary touch region is separable around the selected touch sensor.

Here, the second touch IC 220 may input the touch sensitivity of the touch sensors positioned within the certain distance from the touch sensors whose touch sensitivity is the reference value or more into a pre-trained neural network model to predict the touch sensor of the separation reference based on the touch sensitivity level distribution.

In addition, when the boundary touch region of the big touch is separated, the second touch IC 220 may transmit touch coordinate information, touch sensitivity information, a number of touch sensors of the separated boundary touch region, and boundary touch information including touch sensing data corresponding to all touch sensors positioned within the boundary touch region to the first touch IC 210.

As an example, the touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

In some cases, when the boundary touch region of the big touch is not separable, the second touch IC 220 may transmit the big touch information of the big touch excluding touch sensing data corresponding to all touch sensors positioned within the entire big touch region of the second region R2 to the first touch IC 210.

Here, the second touch IC 220 may transmit big touch information including big touch coordinate information, big touch sensitivity information, and a number of big touch sensors to the first touch IC 210.

For example, the big touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of big touch sensors may include a total number of touch sensors within the big touch region covered by the big touch.

Next, the second touch IC 220 may transmit the boundary touch information of the separated boundary touch region to the first touch IC 210 and process big touch data of a remaining big touch region excluding the boundary touch region based on the touch sensing signal.

Here, when processing the big touch data of the remaining big touch region excluding the boundary touch region, the second touch IC 220 may store the processed big touch data in the memory and transmit the stored big touch data to the first touch IC 210 when receiving a transmission request of the big touch data from the first touch IC 210 which is pre-selected as the master IC.

In some cases, when processing the big touch data, the second touch IC 220 may store the processed big touch data in the memory, receive the first touch data of the first region R1 and the third touch data of the boundary touch region from the first touch IC 210 when the second touch IC 220 is selected as the master IC, generate touch information based on the first touch data of the first region R1, the second touch data of the second region R2, and the third touch data of the boundary touch region, and transmit the generated touch information to the host 300.

Here, the second touch IC 220 may check whether the second touch IC 220 has been pre-selected as the master IC after processing the big touch data of the second region R2 and request the first touch IC 210 to transmit the first touch data of the first region R1 and the third touch data of the boundary touch region when the second touch IC 220 is pre-selected as the master IC.

In this case, the second touch IC 220 may check through pre-stored user setting information or through a user input requesting selection as the master IC when checking whether the second touch IC 220 has been pre-selected as the master IC.

In addition, when generating touch information, the second touch IC 220 may generate touch information including touch coordinate information, touch sensitivity information, and a number of touch sensors.

Here, when generating touch information, the second touch IC 220 may also generate touch information including touch sensing data corresponding to all touch sensors positioned within the touch region.

Further, when generating touch information, the second touch IC 220 may further generate the touch information including the touch coordinate information, the touch sensitivity information, and the number of touch sensors, overall touch size information, and information on a number of touch sensors of a boundary surface around a boundary line BL.

As an example, the touch coordinate information may include an X end touch sensor coordinate, a Y start touch sensor coordinate, and a Y end touch sensor coordinate, the touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

In some cases, when generating touch information, the first touch IC 210 may generate touch tracking information based on the first touch data of the first region R1, the second touch data of the second region R2, and the third touch data of the boundary touch region and transmit the touch tracking information together with the touch information to the host 300.

In addition, each of the first and second touch ICs 210 and 220 may include one or more read-out integrated circuits (ROICs) configured to supply a touch driving signal to the touch panel 100 and receive a touch sensing signal from the touch panel 100 and a micro controller unit (MCU) configured to determine the presence or position of a big touch of a touch input using touch sensing signal detection results.

Here, one or more ROICs may be implemented as individual components or as one integrated component.

As another embodiment, each of the first and second touch ICs 210 and 220 may include only ROIC and may be implemented such that one MCU is separated to be commonly connected to a plurality of touch ICs.

Here, the MCU may determine whether there is a big touch based on the touch sensing signal received from the ROIC.

That is, the MCU may check whether there is a touch on a boundary surface of the second region adjacent to the first region based on a touch sensing signal when the touch sensing signal corresponding to the second region of the touch panel is input from the second touch IC 220, check whether the touch is a big touch of a preset size or more when there is the touch on the boundary surface, separate a boundary touch region adjacent to the boundary surface out of an entire region of the big touch when the touch is a big touch, and store boundary touch information of the separated boundary touch region.

Next, when a touch sensing signal corresponding to the first region of the touch panel is input from the first touch IC 210, the MCU may process the first touch data of the first region based on the touch sensing signal and process the third touch data of the boundary touch region within the second region based on the boundary touch information of the boundary touch region.

Here, when the touch sensing signal corresponding to the first region of the touch panel is input from the first touch IC 210, the MCU may check whether there is the touch on the boundary surface of the first region adjacent to the second region based on the touch sensing signal and check whether the boundary touch region adjacent to the boundary surface of the first region out of an entire region of the touch is separable.

That is, when the boundary touch information is stored based on the touch sensing signal corresponding to the second region of the touch panel, the MCU may check whether the boundary touch region within the first region is separable based on the touch sensing signal corresponding to the first region of the touch panel, process the first touch data of the boundary touch region within the first region when the boundary touch region within the first region R1 is separable, and process the third touch data of the boundary touch region within the second region based on the continuously stored boundary touch information.

When checking whether the boundary touch region within the first region is separable, the MCU may acquire touch sensitivity of the entire touch region of the first region R1 based on the touch sensing signal, acquire touch sensitivity of the boundary touch region within the second region R2 from the boundary touch information, search for touch sensors whose touch sensitivity is a reference value or more based on the acquired touch sensitivity, and analyze the touch sensitivity of touch sensors positioned between the touch sensors whose touch sensitivity is the reference value or more to check whether the boundary touch region within the first region is separable.

As an example, when the touch sensitivity of touch sensors positioned between the touch sensors whose touch sensitivity is the reference value or more gradually decreases and then increases, the MCU may check that the boundary touch region is separable around the touch sensor with the lowest level of touch sensitivity.

As another example, the MCU may input the touch sensitivity of the touch sensors positioned between the touch sensors whose touch sensitivity is the reference value or more into a pre-trained neural network model to predict a touch sensor of separation reference based on a touch sensitivity level distribution.

As still another example, when touch sensitivity of touch sensors positioned within a certain distance from touch sensors whose touch sensitivity is the reference value or more have a preset sensitivity level distribution, the MCU may select a touch sensor that becomes a separation reference based on the preset sensitivity level distribution and check that the boundary touch region is separable around the selected touch sensor.

In addition, the MCU may generate big touch information based on the first touch data of the first region, the second touch data of the second region, and the third touch data of the boundary touch region within the second region, and transmit the generated big touch Information to the host.

Here, when generating the big touch information, the MCU may generate big touch information including big touch coordinate information, big touch sensitivity information, and a number of big touch sensors.

In some cases, when generating the big touch information, the MCU 220 may generate touch tracking information based on the first touch data of the first region, the second touch data of the second region, and the third touch data of the boundary touch region within the second region and transmit the touch tracking information together with the big touch information to the host.

In addition, when it is determined that the touch of the second region is not a big touch of the preset size or more or the big touch is separatable, the MCU may extract boundary touch information including touch sensing data from pre-stored boundary touch information.

In addition, when it is determined that the touch of the second region is a big touch of the preset size or more or the big touch is not separatable, the MCU may extract boundary touch information not including the touch sensing data from the pre-stored boundary touch information.

Next, the MCU may recognize that there is a touch on the boundary surface adjacent to the first region when a touch sensing signal is input from at least one of touch sensors arranged in a first column of the second region on the boundary surface when checking whether there is a touch on the boundary surface adjacent to the first region.

In addition, when touch sensing signals are not input from the touch sensors arranged in the first column of the second region on the boundary surface, the MCU may recognize that there is no touch on the boundary surface adjacent to the first region.

Here, the MCU may check that touch sensing signals are input from touch sensors arranged in columns other than the first column of the second region when there is no touch on the boundary surface adjacent to the first region and process the second touch data in the second region based on touch sensing signals when the touch sensing signals are input from touch sensors arranged in other columns.

In addition, the MCU may check whether the touch is continuous from the touch sensor arranged in the first column of the second region on the boundary surface to a touch sensor arranged in an Nth reference column and recognize the touch as the big touch of the preset size or more when the touch is continuous when checking whether the touch is the big touch of the preset size or more.

In addition, when the touch is continuous from the touch sensor arranged in the first column of the second region to the touch sensor arranged in an N−1th column on the boundary surface, the MCU may recognize the touch as a normal touch smaller than the big touch.

Next, when separating the boundary touch region adjacent to the boundary surface, the MCU may check whether the boundary touch region adjacent to the boundary surface out of the entire region of the big touch is separable, separate a boundary touch region of the big touch when the boundary touch region is separable, store the boundary touch information of the separated boundary touch region in the memory.

As such, in the present disclosure, it is possible to accurately recognize the big touch of a touch panel and process the big touch efficiently and quickly by transmitting only necessary information of a boundary touch region out of an entire region of a big touch to an adjacent touch IC when a boundary surface touch between different regions of the touch panel is the big touch.

That is, in the present disclosure, when the boundary surface touch is the big touch, if finger separation of the big touch is possible is possible, only touch information of a part of a separable boundary surface out of the entire region of the big touch is transmitted to the adjacent touch IC or if the finger separation of the big touch is not possible, only some of the touch information, excluding touch sensing data, out of total touch information of the big touch is transmitted to the adjacent touch IC, thereby processing the big touch efficiently and quickly by minimizing a transmission amount and a transmission time of touch information.

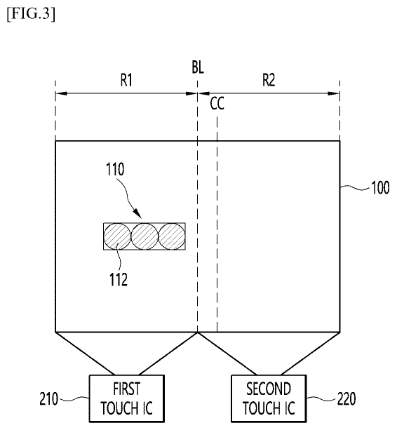

FIGS. 3 to 8 are diagrams for describing operations corresponding to touch positions of a touch sensing apparatus according to an embodiment of the present disclosure.

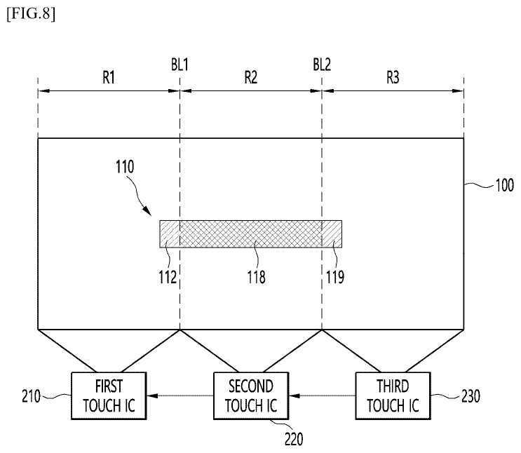

FIGS. 3 to 7 are diagrams for describing a processing operation of a touch signal corresponding to each divided region using two touch ICs when a touch panel is divided into two regions, and FIG. 8 is a diagram for describing a processing operation of a touch signal corresponding to each divided region using three touch ICs when divided into three regions.

As shown in FIGS. 3 to 7, in the present disclosure, the touch sensing apparatus may include a first touch IC 210 configured to generate first touch data corresponding to a first region R1 of a touch panel 100 and a second touch IC 220 configured to generate second touch data corresponding to a second region R2 adjacent to the first region R1 based on a boundary line BL.

Here, the second region R2 may include a boundary touch region between the boundary line BL between the first region R1 and the second region R2 and a preset reference column CC.

First, as shown in FIG. 3, when a touch 110 occurs only in the first region R1 of the touch panel 100, the first touch IC 210 may process first touch data 112 of the first region based on a touch sensing signal when the touch sensing signal is input from a touch sensor positioned in the first region R1 of the touch panel 100.

Here, the first touch IC 210 may check whether the touch 110 of the first region R1 is a continuous touch extending up to the boundary line BL based on the touch sensing signal.

When it is determined that the touch 110 of the first region R1 is not the continuous touch extending up to the boundary line BL, the first touch IC 210 may process the first touch data 112 corresponding to the touch 110 of the first region R1.

In addition, when it is determined that the touch 110 of the first region R1 is the continuous touch extending up to the boundary line BL, the first touch IC 210 may check whether a boundary touch region adjacent to the boundary line BL out of an entire region of the touch 110 is separable and process the first touch data 112 corresponding to the touch 110 of the first region R1 excluding only the boundary touch region when the boundary touch region is separable.

Here, the first touch IC 210 may process touch data for the boundary touch region after receiving touch information corresponding to the boundary touch region from the second touch IC 220.

In addition, when processing the first touch data 112 corresponding to the touch 110 of the first region R1, the first touch IC 210 may check whether the touch 110 of the first region R1 is separatable, and when the touch 110 of the first region R1 is separable, the first touch IC 210 may process the first touch data 112 corresponding to the touch 110 of the first region R1 by separating the touch 110 of the first region R1.

As an example, when the touch 110 of the first region R1 is separable, the first touch IC 210 may recognize a touch means as a finger and determine that finger separation is possible.

In addition, when checking whether the touch 110 of the first region R1 is separable, the first touch IC 210 may acquire touch sensitivity of the entire region of the touch 110 of the first region R1 based on the touch sensing signal, search for touch sensors whose touch sensitivity is a reference value or more based on the acquired touch sensitivity, and analyze the touch sensitivity of touch sensors positioned between the touch sensors whose touch sensitivity is the reference value or more to check whether the touch 110 of the first region R1 is separable.

As an embodiment, when the touch sensitivity of touch sensors positioned between the touch sensors whose touch sensitivity is the reference value or more gradually decreases and then increases, the first touch IC 210 may check that the touch 110 of the first region R1 is separable around the touch sensor with the lowest level of touch sensitivity.

Here, when touch sensitivity of a touch sensor positioned at an X coordinate among the touch sensors positioned between the touch sensors whose touch sensitivity is the reference value or more gradually decreases and then increases, the first touch IC 210 may check that the touch 110 of the first region R1 is separable around the touch sensor with the lowest level of touch sensitivity.

In some cases, when touch sensitivity of a touch sensor positioned at a Y coordinate among touch sensors positioned between touch sensors whose touch sensitivity is the reference value or more gradually decreases and then increases, the first touch IC 210 may check that the touch 110 of the first region R1 is separable around the touch sensor with the lowest level of touch sensitivity.

As another case, when the touch sensitivity of the touch sensor positioned at the X coordinate and the touch sensitivity of the touch sensor positioned at the Y coordinate among touch sensors positioned between touch sensors whose touch sensitivity is the reference value or more gradually decrease and then increase, the first touch IC 210 may check that the touch 110 of the first region R1 is separable around the touch sensor with the lowest level of touch sensitivity.

As another embodiment, the first touch IC 210 may input the touch sensitivity of the touch sensors positioned between the touch sensors whose touch sensitivity is the reference value or more into a pre-trained neural network model to predict a touch sensor of separation reference based on a touch sensitivity level distribution.

As still another embodiment, when touch sensitivity of touch sensors positioned within a certain distance from touch sensors whose touch sensitivity is the reference value or more have a preset sensitivity level distribution, the first touch IC 210 may select a touch sensor that becomes a separation reference based on the preset sensitivity level distribution and check that the touch 110 of the first region R1 is separable around the selected touch sensor.

Here, the first touch IC 210 may input the touch sensitivity of the touch sensors positioned within the certain distance from the touch sensors whose touch sensitivity is the reference value or more into a pre-trained neural network model to predict the touch sensor of the separation reference based on the touch sensitivity level distribution.

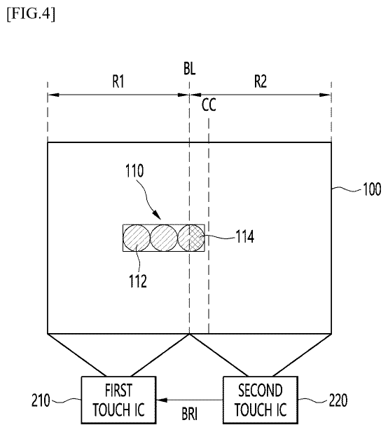

Next, as shown in FIG. 4, when a touch 110 occurs in the first region R1 and the boundary touch region of the second region R2 of the touch panel 100, the first touch IC 210 may process first touch data 112 of the first region R1 based on a touch sensing signal when the touch sensing signal is input from a touch sensor positioned in the first region R1 of the touch panel 100, and when receiving boundary touch information BRI of the boundary touch region from the touch IC 220, the first touch IC 210 may process the third touch data 114 of a boundary touch region within the second region R2 based on the boundary touch information BRI.

Here, the boundary touch region may be a region between a boundary line BL between the first region R1 and the second region R2 and a preset reference column CC and include a peripheral region of a boundary line within the second region.

The first touch IC 210 may process the first touch data of the first region R1 and simultaneously receive the boundary touch information BRI of the boundary touch region within the second region R2 from the second touch IC 220.

In addition, when receiving the boundary touch information BRI from the second touch IC 220, the first touch IC 210 may process continuously the third touch data 114 of the boundary touch region within the second region R2 based on the boundary touch information BRI after processing the first touch data 112 of the first region R1.

In addition, after receiving the boundary touch information BRI from the second touch IC 220, the first touch IC 210 may check whether there is a touch 110 on the boundary surface of the first region R1 adjacent to the second region R2 and check whether the boundary touch region adjacent to the boundary surface of the first region R1 out of an entire region of the touch 110 is separable.

As an example, the first touch IC 210 may wait until all boundary touch information BRI has been received from the second touch IC 220, check whether the boundary touch region within the first region R1 is separable when all boundary touch information BRI has been received from the second touch IC 220, process the first touch data 112 of the boundary touch region within the first region R1 when the boundary touch region within the first region R1 is separable, and process the third touch data 114 of the boundary touch region within the second region R2 based on the boundary touch information BRI that has been received continuously.

Here, when checking whether the boundary touch region within the first region R1 is separable, the first touch IC 210 may acquire touch sensitivity of the entire touch region of the first region R1 based on the touch sensing signal, acquire touch sensitivity of the boundary touch region within the second region R2 from the boundary touch information received from the second touch IC 220, search for touch sensors whose touch sensitivity is a reference value or more based on the acquired touch sensitivity, and analyze the touch sensitivity of touch sensors positioned between the touch sensors whose touch sensitivity is the reference value or more to check whether the boundary touch region within the first region R1 is separable.

Meanwhile, the second touch IC 220 may check whether there is the touch 110 at a boundary surface of the second region R2 adjacent to the first region R1 based on a touch sensing signal when the touch sensing signal is input from a touch sensor positioned in the second region R2 of the touch panel 100 and check whether the touch 110 is the big touch of the preset size or more when there is the touch 110 at the boundary surface.

Here, the second touch IC 220 may check whether the touch 110 is continuous from a touch sensor arranged in a first column of the second region R2 with respect to the boundary line BL to a touch sensor arranged in an Nth reference column CC and recognize the touch as the big touch of the preset size or more when the touch 110 is continuous when checking whether the touch 110 is the big touch of the preset size or more.

However, as shown in FIG. 4, when the touch 110 is continuous from the touch sensor arranged in the first column of the second region R2 to a touch sensor arranged in an N−1th column at the boundary surface, the second touch IC 220 may recognize the touch as a normal touch smaller than the big touch.

Therefore, as shown in FIG. 4, when recognizing the touch 110 as the normal touch, the second touch IC 220 may transmit the boundary touch information BRI of the boundary touch region adjacent to the boundary to the first touch IC 210.

Here, when transmitting the boundary touch information BRI, the second touch IC 220 may transmit touch coordinate information, touch sensitivity information, a number of touch sensors of the boundary touch region, and boundary touch information BRI including touch sensing data corresponding to all touch sensors positioned within the boundary touch region to the first touch IC 210.

As an example, the touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

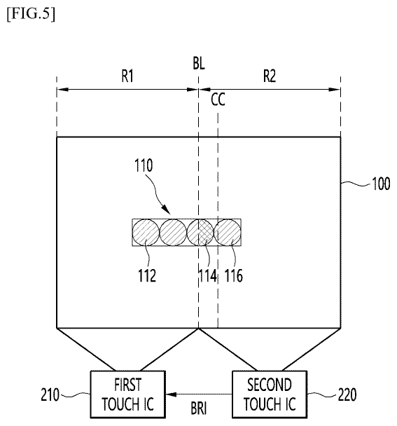

Next, as shown in FIG. 5, when a touch 110 occurs in the first region R1, the second region R2, and the boundary touch region of the second region R2 of the touch panel 100, the first touch IC 210 may process first touch data 112 of the first region R1 based on a touch sensing signal when the touch sensing signal is input from a touch sensor positioned in the first region R1 of the touch panel 100, and when receiving boundary touch information BRI of the boundary touch region from the touch IC 220, the first touch IC 210 may process the third touch data 114 of the boundary touch region within the second region R2 based on the boundary touch information BRI.

In addition, the second touch IC 220 may check whether there is the touch 110 on a boundary surface of the second region R2 adjacent to the first region R1 based on a touch sensing signal when the touch sensing signal is input from a touch sensor positioned in the second region R2 of the touch panel 100, check whether the touch 110 is the big touch of the preset size or more when there is the touch 110 on the boundary surface, separate a boundary touch region adjacent to the boundary surface out of an entire region of the big touch when the touch is the big touch, and transmit boundary touch information BRI of the separated boundary touch region to the first touch IC 210.

Next, the second touch IC 220 may process second touch data 116 corresponding to a region other than the separated boundary touch region out of the second region R2.

Here, the second touch IC 220 may check whether the touch 110 is continuous from a touch sensor arranged in a first column of the second region R2 with respect to the boundary line BL to a touch sensor arranged in an Nth reference column CC and recognize the touch as the big touch of the preset size or more when the touch 110 is continuous when checking whether the touch 110 is the big touch of the preset size or more.

In addition, when separating the boundary touch region adjacent to the boundary surface, the second touch IC 220 may check whether the boundary touch region adjacent to the boundary line BL out of the entire region of the big touch is separable, and when the boundary touch region is separable, the second touch IC may separate the boundary touch region of the big touch and transmit boundary touch information of the separated boundary touch region to the first touch IC 210.

Here, when checking whether the boundary touch region of the big touch is separable, the second touch IC 220 may acquire touch sensitivity of the entire big touch region of the second region R2 based on the touch sensing signal, search for touch sensors whose touch sensitivity is the reference value or more based on the acquired touch sensitivity, and analyze the touch sensitivity of touch sensors positioned between the touch sensors whose touch sensitivity is the reference value or more to check whether the boundary touch region of the big touch is separable.

When transmitting the boundary touch information BRI, the second touch IC 220 may transmit touch coordinate information, touch sensitivity information, a number of touch sensors of the boundary touch region, and boundary touch information including touch sensing data corresponding to all touch sensors positioned within the boundary touch region to the first touch IC 210.

As such, in the present disclosure, when the boundary surface touch is a big touch, if finger separation of the big touch is possible, only touch information of a part of a separable boundary surface out of the entire region of the big touch is transmitted to the adjacent touch IC, thereby processing the big touch efficiently and quickly by minimizing a transmission amount and a transmission time of touch information.

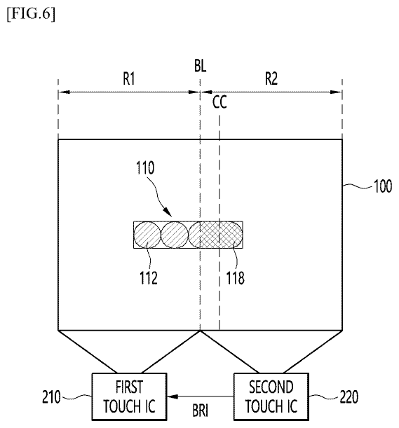

In addition, as shown in FIG. 6, when a touch 110 occurs in the first region R1, the second region R2, and the boundary touch region of the second region R2 of the touch panel 100, the first touch IC 210 may process first touch data 112 of the first region R1 based on a touch sensing signal when the touch sensing signal is input from a touch sensor positioned in the first region R1 of the touch panel 100, and when receiving big touch information from the second touch IC 220, the first touch IC 210 may process big touch data 118 within the second region R2 based on the big touch information.

In addition, the second touch IC 220 may check whether there is the touch 110 on a boundary surface of the second region R2 adjacent to the first region R1 based on a touch sensing signal when the touch sensing signal is input from a touch sensor positioned in the second region R2 of the touch panel 100, check whether the touch 110 is the big touch of the preset size or more when there is the touch 110 at the boundary surface, check whether the big touch is separatable when the touch 110 is the big touch, and transmit big touch information corresponding to the big touch to the first touch IC 210 when the big touch is not separated.

That is, when the boundary touch region of the big touch is not separable, the second touch IC 220 may transmit the big touch information of the big touch excluding touch sensing data corresponding to all touch sensors positioned within the entire big touch region of the second region R2 to the first touch IC 210.

Here, the second touch IC 220 may transmit big touch information including big touch coordinate information, big touch sensitivity information, and a number of big touch sensors to the first touch IC 210.

For example, the big touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of big touch sensors may include a total number of touch sensors within the big touch region covered by the big touch.

As such, in the present disclosure, when the boundary touch is a big touch, if finger separation of the big touch is not possible, only some touch information excluding touch sensing data among the total touch information of the big touch is transmitted to the adjacent touch IC, thereby processing the big touch efficiently and quickly by minimizing a transmission amount and a transmission time of touch information.

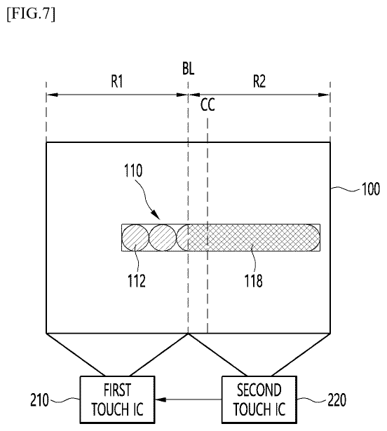

Next, as shown in FIG. 7, when a touch 110 continuously occurs across both boundary lines in a row direction of a part of the first region R1 and the second region R2 of the touch panel 100, the first touch IC 210 may process first touch data 112 of the first region R1 based on a touch sensing signal when the touch sensing signal is input from a touch sensor positioned in the first region R1 of the touch panel 100, and when receiving big touch information from the second touch IC 220, the first touch IC 210 may process big touch data 118 within the second region R2 based on the big touch information.

In addition, the second touch IC 220 may check whether there is the touch 110 on a boundary surface of the second region R2 adjacent to the first region R1 based on a touch sensing signal when the touch sensing signal is input from a touch sensor positioned in the second region R2 of the touch panel 100, check whether the touch 110 is the big touch of the preset size or more when there is the touch 110 at the boundary surface, check whether the big touch is separatable when the touch 110 is the big touch, and transmit big touch information corresponding to the big touch to the first touch IC 210 when the big touch is not separated.

That is, when the boundary touch region of the big touch is not separable, the second touch IC 220 may transmit the big touch information of the big touch excluding touch sensing data corresponding to all touch sensors positioned within the entire big touch region of the second region R2 to the first touch IC 210.

Here, the second touch IC 220 may transmit big touch information including big touch coordinate information, big touch sensitivity information, and a number of big touch sensors to the first touch IC 210.

Next, as shown in FIG. 8, the present disclosure may include a first touch IC 210 configured to generate first touch data 112 corresponding to the first region R1 of the touch panel 100, a second touch IC 220 configured to generate big touch data 118 corresponding to the second region R2 adjacent to the first region R1 based on a first boundary line BL1 of the touch panel 100, and a third touch IC 230 configured to generate fourth touch data 119 corresponding to a third region R3 adjacent to the second region R2 based on a second boundary line BL2 of the touch panel 100.

When a touch 110 occurs in the first region R1, the second region R2, and the third region R3 of the touch panel 100, the first touch IC 210 may process first touch data 112 of the first region R1 based on a touch sensing signal when the touch sensing signal is input from a touch sensor positioned in the first region R1 of the touch panel 100, and when receiving big touch information from the second touch IC 220, the first touch IC 210 may process big touch data 118 within the second region R2 based on the big touch information.

In addition, the second touch IC 220 may check whether there is the touch 110 on a boundary surface of the second region R2 adjacent to the first region R1 based on a touch sensing signal when the touch sensing signal is input from a touch sensor positioned in the second region R2 of the touch panel 100, check whether the touch 110 is the big touch of the preset size or more when there is the touch 110 at the boundary surface, check whether the big touch is separatable when the touch 110 is the big touch, and transmit big touch information corresponding to the big touch to the first touch IC 210 when the big touch is not separated.

That is, when the boundary touch region of the big touch is not separable, the second touch IC 220 may transmit the big touch information of the big touch excluding touch sensing data corresponding to all touch sensors positioned within the entire big touch region of the second region R2 to the first touch IC 210.

Next, when receiving boundary touch information BRI of a boundary touch region from the third touch IC 230, the second touch IC 220 may process the fourth touch data 119 of the boundary touch region within the third region R3 based on the boundary touch information BRI.

In addition, the third touch IC 230 may check whether there is the touch 110 on a boundary surface of the third region R3 adjacent to the second region R2 based on a touch sensing signal when the touch sensing signal is input from a touch sensor positioned in the third region R3 of the touch panel 100, check whether the touch 110 is the big touch of the preset size or more when there is the touch 110 on the boundary surface, separate a boundary touch region adjacent to the boundary surface out of an entire region of the big touch when the touch is a big touch, and transmit boundary touch information BRI of the separated boundary touch region to the second touch IC 220.

Next, the third touch IC 230 may process touch data corresponding to a region other than the separated boundary touch region out of the third region R3.

Here, the third touch IC 230 may check whether the touch 110 is continuous from a touch sensor arranged in a first column of the third region R3 with respect to the second boundary line BL2 to a touch sensor arranged in an Nth reference column and recognize the touch as the big touch of the preset size or more when the touch 110 is continuous when checking whether the touch 110 is the big touch of the preset size or more.

In addition, when separating the boundary touch region adjacent to the boundary surface, the third touch IC 230 may check whether the boundary touch region adjacent to the second boundary line BL2 out of the entire region of the big touch is separable, and is when the boundary touch region is separable, the third touch IC may separate the boundary touch region of the big touch and transmit boundary touch information of the separated boundary touch region to the second touch IC 220.

As another embodiment, the third touch IC 230 may transmit the boundary touch information BRI of the separated boundary touch region to the first touch IC 210.

Here, the first touch IC 210 may process the first touch data 112 of the first region R1 based on the touch sensing signal when a touch sensing signal is input from the touch sensor positioned in the first region R1 of the touch panel 100, process big touch data 118 within the second region R2 based on the big touch information when receiving big touch information from the second touch IC 220, and process the fourth touch data 119 of the boundary touch region within the third region R3 based on boundary touch information when receiving the boundary touch information from the third touch IC 230.

As such, in the present disclosure, when the boundary surface touch is the big touch, if finger separation of the big touch is possible is possible, only touch information of a part of a separable boundary surface out of the entire region of the big touch is transmitted to the adjacent touch IC or if the finger separation of the big touch is not possible, only some of the touch information, excluding touch sensing data, out of total touch information of the big touch is transmitted to the adjacent touch IC, thereby processing the big touch efficiently and quickly by minimizing a transmission amount and a transmission time of touch information.

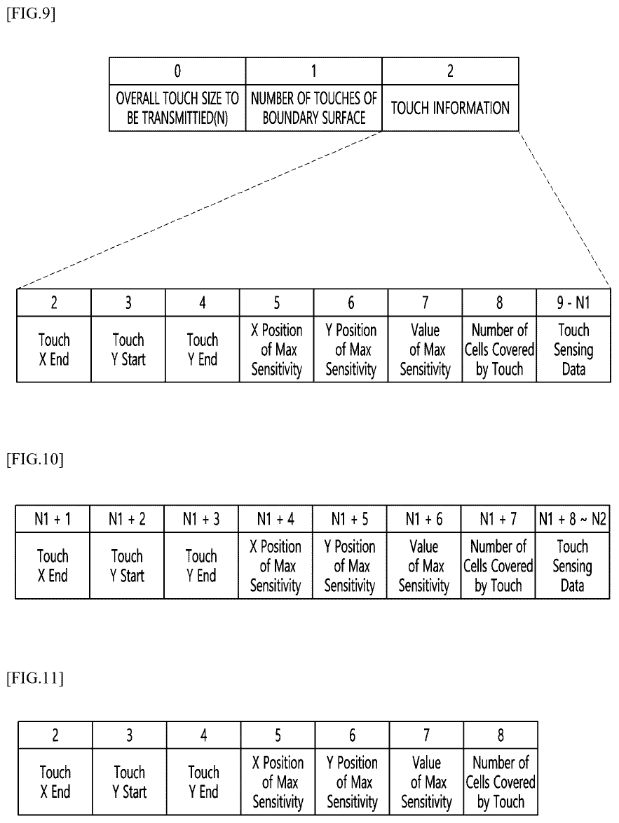

FIGS. 9 to 11 are diagrams for describing touch information transmitted between touch ICs.

FIG. 9 shows touch information generated based on a touch sensing signal of a corresponding region when there is a touch in a region other than the boundary surface between the first region and the second region of the touch panel.

As shown in FIG. 9, the touch IC may generate touch information including touch sensing data, touch coordinate information, touch sensitivity information, and a number of touch sensors based on the touch sensing signal of the touch region.

Further, the touch IC may further generate the touch information including the touch coordinate information, the touch sensitivity information, and the number of touch sensors, overall touch size information, and information on a number of touch sensors of the boundary surface around the boundary line.

As an example, the touch coordinate information may include an X end touch sensor coordinate, a Y start touch sensor coordinate, and a Y end touch sensor coordinate, the touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

FIG. 10 shows touch information generated based on a touch sensing signal of a boundary region when there is a touch on the boundary surface between the first and second regions of the touch panel.

As shown in FIG. 10, the touch IC may generate touch information including touch sensing data, touch coordinate information, touch sensitivity information, and a number of touch sensors based on the touch sensing signal of the boundary region.

As an example, the touch coordinate information may include an X end touch sensor coordinate, a Y start touch sensor coordinate, and a Y end touch sensor coordinate, the touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

FIG. 11 shows touch information generated based on a touch sensing signal of a big touch region when there is a big touch including the boundary surface between the first and second regions of the touch panel.

As shown in FIG. 11, the touch IC may generate touch information including touch coordinate information excluding touch sensing data, touch sensitivity information, and a number of touch sensors based on the touch sensing signal of the big touch region.

As an example, the touch coordinate information may include an X end touch sensor coordinate, a Y start touch sensor coordinate, and a Y end touch sensor coordinate, the touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

As such, when determining that the touch is a touch excluding the boundary surface between the first and second regions of the touch panel based on the touch sensing signal, the touch IC of the present disclosure may generate the touch information including the touch sensing data as shown in FIG. 9.

In addition, when determining that the touch is a touch including the boundary surface between the first and second regions of the touch panel based on the touch sensing signal and is not a big touch with a large touch size, the touch IC of the present disclosure may generate touch information including the touch sensing data as shown in FIG. 10 to transmit to an adjacent touch IC.

Next, when determining that the touch is a touch including the boundary surface between the first and second regions of the touch panel based on the touch sensing signal and is a big touch with a large touch size, the touch IC of the present disclosure may generate touch information excluding the touch sensing data as shown in FIG. 11 to transmit to an adjacent touch IC.

In addition, when determining that the touch is a touch including the boundary surface between the first and second regions of the touch panel based on the touch sensing signal, is a big touch with a large touch size, and a boundary surface region out of the big touch is separable, the touch IC of the present disclosure may separate the boundary surface region out of the big touch and generate touch information including the touch sensing data corresponding to the separated boundary surface region as shown in FIG. 10 to transmit to an adjacent touch IC.

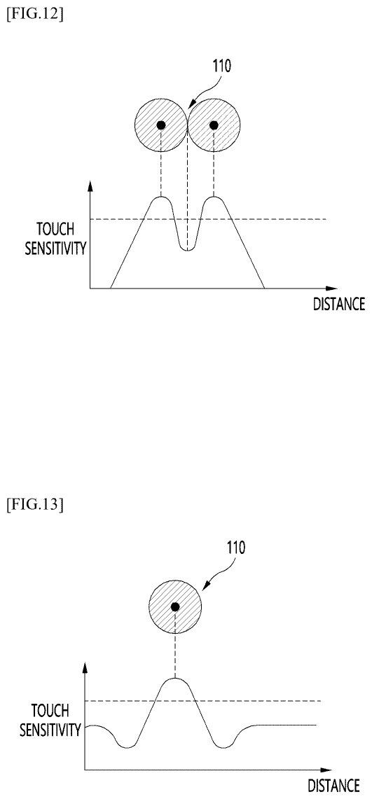

FIGS. 12 to 14 are diagrams for describing an operation of a touch region separation method of a touch sensing apparatus according to an embodiment of the present disclosure.

As shown in FIGS. 12 to 14, the touch IC of the present disclosure may determine whether a big touch is separatable and generate touch information including touch sensing data or touch information not including touch sensing data according to whether the big touch is separatable.

Here, when the big touch is separable, the touch IC of the present disclosure may recognize a touch means as a finger and determine that finger separation is possible.

In some cases, when the big touch is separable, the touch IC of the present disclosure may recognize the touch means as an object other than the finger and determine that object separation is possible.

In addition, the touch IC of the present disclosure may check whether the big touch includes the boundary surface between the first and second regions of the touch panel and determine whether the boundary surface region out of the entire region of the big touch is separatable.

As shown in FIGS. 12 to 14, when determining whether a touch region is separable, the touch IC of the present disclosure may acquire touch sensitivity of an entire touch region based on a touch sensing signal, search for touch sensors whose touch sensitivity is a reference value or more based on the acquired touch sensitivity, and analyze the touch sensitivity of touch sensors positioned between the touch sensors whose touch sensitivity is the reference value or more to check whether the touch 110 is separable.

As an embodiment, as shown in FIG. 12, when the touch sensitivity of touch sensors positioned between the touch sensors whose touch sensitivity is the reference value or more gradually decreases and then increases, the touch IC of the present disclosure may check that the touch 110 is separable around the touch sensor with the lowest level of touch sensitivity.

Here, when touch sensitivity of a touch sensor positioned at an X coordinate among the touch sensors positioned between the touch sensors whose touch sensitivity is the reference value or more gradually decreases and then increases, the touch IC may check that the touch 110 is separable around the touch sensor with the lowest level of touch sensitivity.

In some cases, when touch sensitivity of a touch sensor positioned at a Y coordinate among touch sensors positioned between touch sensors whose touch sensitivity is the reference value or more gradually decreases and then increases, the touch IC may check that the touch 110 is separable around the touch sensor with the lowest level of touch sensitivity.

As another case, when the touch sensitivity of the touch sensor positioned at the X coordinate and the touch sensitivity of the touch sensor positioned at the Y coordinate among touch sensors positioned between touch sensors whose touch sensitivity is the reference value or more gradually decrease and then increase, the touch IC may check that the touch 110 is separable around the touch sensor with the lowest level of touch sensitivity.

As another embodiment, as shown in FIG. 13, when touch sensitivity of touch sensors positioned within a certain distance from touch sensors whose touch sensitivity is the reference value or more have a preset sensitivity level distribution, the touch IC of the present disclosure may select a touch sensor that becomes a separation reference based on the preset sensitivity level distribution and check that the touch 110 is separable around the selected touch sensor.

Here, the touch IC may input the touch sensitivity of the touch sensors positioned within the certain distance from the touch sensors whose touch sensitivity is the reference value or more into a pre-trained neural network model to predict the touch sensor of the separation reference based on the touch sensitivity level distribution.

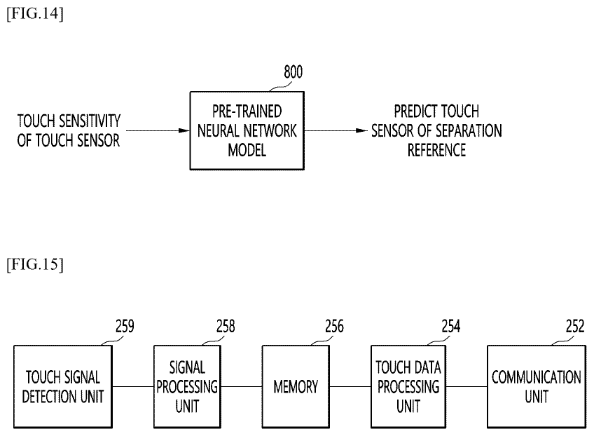

As another embodiment, as shown in FIG. 14, the touch IC of the present disclosure may input the touch sensitivity of the touch sensors positioned between touch sensors whose touch sensitivity is the reference value or more into a pre-trained neural network model 800 to predict the touch sensor of the separation reference based on the touch sensitivity level distribution.

Here, the neural network model 800 may be a deep neural network including a convolutional neural network (CNN), a recurrent neural network (RNN), a restricted boltzmann machine (RBM), a deep belief network (DBN), a Q network, a U network, a Siamese network, etc.

FIG. 15 is a diagram for describing a touch IC of a touch sensing apparatus according to an embodiment of the present disclosure.

As shown in FIG. 15, a touch IC 250 of the present disclosure may include a communication unit 252, a touch data processing unit 254, a memory 256, a signal processing unit 258, and a touch signal detection unit 259.

Here, the touch signal detection unit 259 may detect a touch sensing signal from a touch sensor of a touch panel.

Here, the touch signal detection unit 259 may include a pulse width modulation (PWM) generation circuit configured to generate a driving pulse, a driving circuit capable of supplying a driving signal to driving electrodes of the touch panel, and a sensing circuit capable of processing a sensing signal received from receiving electrodes.

In this case, the PWM generation circuit may generate a driving pulse for periodic sensing, and the driving circuit may supply a driving signal synchronized with the driving pulse to the touch panel.

In addition, the sensing circuit may sense a voltage or a change in voltage formed in each sensor by the driving signal.

As an example, in the case of a capacitive touch panel, capacitance is formed in the touch sensor, and when the capacitance is changed by a touch, the touch sensor may generate a voltage according to the change in capacitance. Therefore, the sensing circuit may sense a voltage or a change in voltage of the touch sensor.

In some cases, the sensing circuit may sense a sensing signal corresponding to a periodically applied driving signal in a differential manner.

The sensing circuit may further include a differential amplifier circuit to sense the sensing signal in the differential manner, and the sensing circuit may differentially amplify sensing signals of two adjacent receiving electrodes using the differential amplifier circuit.

As such, when the sensing circuit senses in the differential manner, there is an effect that common mode noise is reduced.

Next, the signal processing unit 258 may process the detected touch sensing signal to generate touch sensing data.

Here, the signal processing unit 258 may convert an analog sensing signal processed by the sensing circuit into the touch sensing data and then may store the touch sensing data in the memory 256.

In addition, the memory 256 may store the touch sensing data.

Next, the touch data processing unit 254 may generate touch data for one region of the touch panel using the touch sensing data stored in the memory 256.

Here, when a touch sensing signal is input from a touch sensor positioned in one region of the touch panel, the touch data processing unit 254 may check whether there is a touch on a boundary surface adjacent to another region out of the one region based on the touch sensing signal, check whether the touch is a big touch of a preset size or more when there is the touch on the boundary surface, separate a boundary touch region adjacent to the boundary surface out of an entire region of the big touch when the touch is the big touch, and transmit boundary touch information of the separated boundary touch region to the touch IC.

Next, the communication unit 252 may be connected to communicate with other touch ICs or other devices connected to touch sensors corresponding to other regions of the touch panel.

Here, the communication unit 252 may generate touch information corresponding to a boundary surface between a first region and a second region or touch information related to the big touch to transmit the touch information to another touch IC.

In some cases, the communication unit 252 may receive the touch information corresponding to the boundary surface between the first region and the second region or the touch information related to the big touch from another touch IC.

In addition, the communication unit 252 may transmit touch information generated while the touch signal detection unit 259 receives the touch sensing signal from the touch sensor of the touch panel to a host.

In addition, the communication unit 252 may transmit the touch information generated while the touch signal detection unit 259 receives the touch sensing signal from the touch sensor of the touch panel to another touch IC or may receive touch information from another touch IC.

In addition, the communication unit 252 may receive touch information from another touch IC while the signal processing unit 258 stores the touch sensing data in the memory 256.

In addition, the communication unit 252 may receive touch information from another touch IC while the touch data processing unit 254 is generating touch data for the touch region of the touch panel.

As such, the touch IC of the present disclosure enables parallel processing that simultaneously performs processing operations between internal components, and thus an overall signal processing speed may be improved.

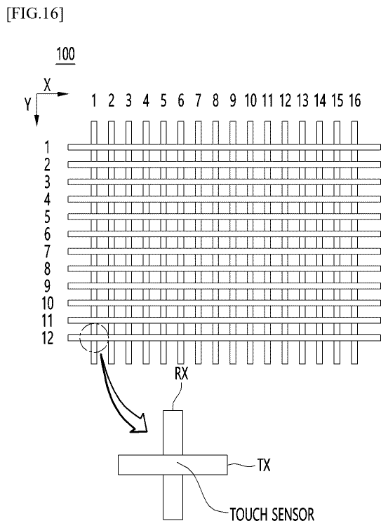

FIGS. 16 to 18 are diagrams for describing a connection relationship between a touch panel and a touch IC according to an embodiment of the present disclosure.

FIG. 16 is a diagram for describing a touch sensor of the touch panel.

As shown in FIG. 16, the touch panel 100 may include a plurality of driving electrodes (TX) arranged in a Y-direction and a plurality of receiving electrodes (RX) arranged in an X-direction, and touch sensors may be formed at positions where the driving electrodes (TX) and the receiving electrodes (RX) intersect.

In addition, the touch sensor may sense a touch using a capacitance generated between electrodes facing each other.

That is, the capacitance of the touch sensor changes when a specific object, such as a finger or a pen, is close to or is in contact with the touch panel, and the touch IC may recognize the touch by measuring a change in capacitance of the touch sensor.

The touch panel 100 of the present disclosure may be driven in a mutual method or a self-method.

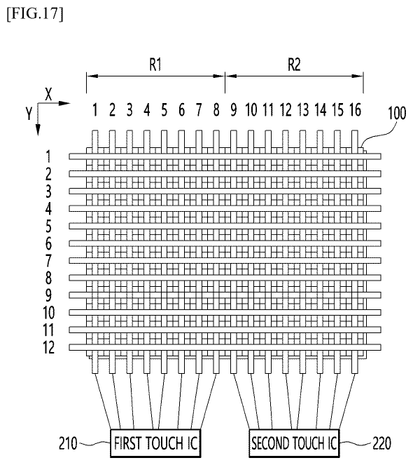

FIG. 17 is a first embodiment showing a connection configuration between the electrodes of the touch panel and the touch IC.

As shown in FIG. 17, the first touch IC 210 may be connected to receiving electrodes X1 to X8 positioned in the first region R1 of the touch panel 100, and the second touch IC 220 may be connected to receiving electrodes X9 to X16 positioned in the second region R2 of the touch panel 100.

Here, when the touch sensing apparatus is driven in a single ended type, a plurality of touch ICs may be sequentially connected to the receiving electrodes as shown in FIG. 17.

A touch sensing apparatus with a single-ended type driving method may input a driving signal to driving electrodes and sense a change in capacitance of the touch sensors through each receiving electrode.

Accordingly, the first touch IC 210 may be connected to the receiving electrodes X1 to X8 positioned in the first region R1 to sense a change in capacitance of touch sensors positioned in the first region R1, and the second touch IC 220 may be connected to the receiving electrodes X9 to X16 positioned in the second region R2 to sense a change in capacitance of touch sensors positioned in the second region R2.

The first touch IC 210 and the second touch IC 220 may generate touch data using a change value in capacitance of the touch sensors.

As an example, the first touch IC 210 may generate touch sensing data by processing touch sensing signals received from the receiving electrodes X1 to X8 (from 1st to 8th) and generate big touch information based on the touch sensing data.

In addition, the second touch IC 220 may generate touch sensing data by processing touch sensing signals received from the receiving electrodes X9 to X16 (from 9th to 16th) and generate touch information or boundary surface touch information of the second region based on the touch sensing data.

Here, a touch IC selected as a master touch IC among the first touch IC 210 and the second touch IC 220 may receive boundary surface touch information from the slave touch IC to transmit big touch information integrating touch information of the first and second regions to a host.

In addition, the driving electrodes may be arranged in the Y-direction to be driven sequentially, and the first touch IC 210 and the second touch IC 220 may generate touch sensing data of a touch region based on touch sensing signals received by a line unit of the driving electrode.

In this case, the second touch IC 220 may transmit touch sensing data to the first touch IC 210 by the line unit of the driving electrode or may transmit touch sensing data to the first touch IC 210 by a frame unit.

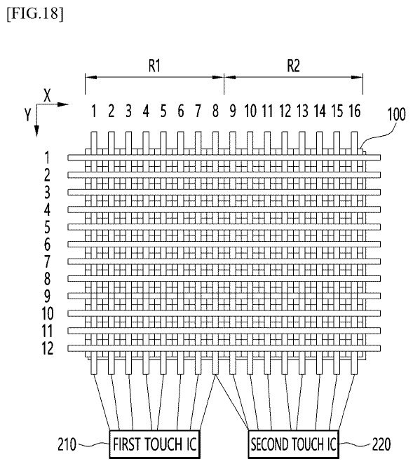

FIG. 18 is a second embodiment showing a connection configuration between the electrodes of the touch panel and the touch IC.

As shown in FIG. 18, the first touch IC 210 may be connected to receiving electrodes X1 to X8 positioned in the first region R1 of the touch panel 100, and the second touch IC 220 may be connected to receiving electrodes X9 to X16 positioned in the second region R2 of the touch panel 100 and the receiving electrode X8 positioned in the first region R1.

Here, when the touch sensing apparatus is driven in a differential type, a plurality of touch ICs may be sequentially connected to the receiving electrodes as shown in FIG. 17.

A touch sensing apparatus with a differential type driving method may input a driving signal to driving electrodes and sense a differential signal from two adjacent receiving electrodes.

In some cases, the first touch IC 210 may be connected to receiving electrodes X1 to X8 positioned in the first region R1 of the touch panel 100 and a receiving electrode X9 in the second region R2, and the second touch IC 220 may be connected to receiving electrodes X9 to X16 positioned in the second region R2 of the touch panel 100.

Since the differential type driving method senses differential signals between touch sensors, the touch IC may calculate a change value in capacitance of the touch sensors by accumulating differential sensing data by such differential signals in one direction.

As an example, the first touch IC 210 and the second touch IC 220 may accumulate differential sensing data in a direction from X16 to X1.

In addition, the second touch IC 220 may generate touch data for the second region R2 by sequentially accumulating differential sensing data from 16th and 15th receiving electrodes to differential sensing data from 9th and 8th receiving electrodes.

Next, when the first touch IC 210 accumulates differential sensing data in the direction from X16 to X1, the first touch IC 210 may receive boundary surface touch data of the second region from the second touch IC 220 to calculate a cumulative value.

That is, the first touch IC 210 may generate touch information of a touch region using differential sensing data generated by processing differential signals received from the receiving electrodes X1 to X8 positioned in the first region R1 and the boundary surface touch data of the second region received from the second touch IC 220.

Here, the second touch IC 220 may transmit the boundary surface touch data to the first touch IC 210 by the line unit of the driving electrode.

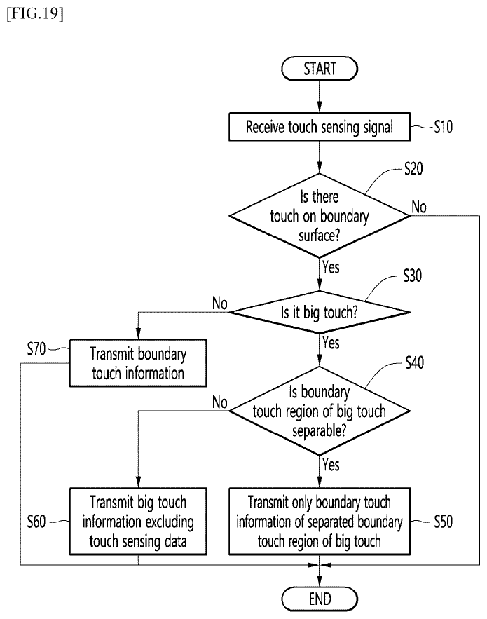

FIGS. 19 to 21 are diagrams for describing a touch sensing method of a touch sensing apparatus according to an embodiment of the present disclosure.

FIG. 19 is a flowchart for describing a touch sensing method of a touch sensing apparatus including a first touch IC configured to generate first touch data corresponding to a first region of a touch panel and a second touch IC configured to generate second touch data corresponding to a second region adjacent to the first region of the touch panel.

In some cases, in the present disclosure, when the touch panel is divided into a plurality of regions in addition to the first region and the second region, and accordingly, the touch sensing apparatus may further include a plurality of touch ICs in addition to the first touch IC and the second touch IC.

As an example, in the present disclosure, a number of separation regions of the touch panel and a number of touch ICs corresponding to each separation region may be the same.

As shown in FIG. 19, the second touch IC of the present disclosure may receive a touch sensing signal from a touch sensor positioned in the second region of the touch panel (S10).

In addition, the second touch IC of the present disclosure may check whether there is a touch on a boundary surface adjacent to the first region out of the second region based on the touch sensing signal (S20).

Here, when the touch sensing signal is input from the touch sensor positioned in the second region of the touch panel before checking whether there is the touch on the boundary surface adjacent to the first region, the second touch IC may check whether there is the first touch IC configured to generate first touch data corresponding the first region and check whether there is the touch on the boundary surface adjacent to the first region when there is the first touch IC.

In some cases, when the first touch IC is not present, the second touch IC may check whether there is the touch in the second region based on the touch sensing signal, check whether a partial touch region out of an entire region of the touch are separable, process touch data of the separated partial touch region when a partial touch region within the second region are separable, and then sequentially process touch data of a remaining touch region.

In addition, the second touch IC may recognize that there is a touch on the boundary surface adjacent to the first region when a touch sensing signal is input from at least one of touch sensors arranged in a first column of the second region.

In some cases, the second touch IC may recognize that there is no touch on the boundary surface adjacent to the first region when a touch sensing signal is not input from the touch sensors arranged in the first column of the second region.

In this case, the second touch IC may check that touch sensing signals are input from touch sensors arranged in columns other than the first column of the second region when there is no touch on the boundary surface adjacent to the first region and process the second touch data in the second region based on touch sensing signals when the touch sensing signals are input from touch sensors arranged in other columns.

In addition, when the second touch IC may store the processed second touch data in a memory when processing the second touch data of the second region and transmit the stored second touch data to the first touch IC when receiving a transmission request of the second touch data from the first touch IC which is pre-selected as the master IC.

Next, when there is a touch on the boundary surface, the second touch IC of the present disclosure may check whether the touch is a big touch of a preset size or more (S30).

Here, the second touch IC may check whether a touch is continuous from the touch sensor arranged in the first column of the second region on the boundary surface to a touch sensor arranged in an Nth reference column and recognize the touch as the big touch of the preset size or more when the touch is continuous.

In some cases, when the touch is continuous from the touch sensor arranged in the first column of the second region to a touch sensor arranged in an N−1th column on the boundary surface, the second touch IC may recognize the touch as a normal touch smaller than the big touch.

In this case, when recognizing the touch as the normal touch, the second touch IC may transmit the boundary touch information of the boundary touch region adjacent to the boundary to the first touch IC (S70).

As an example, when transmitting the boundary touch information, the second touch IC may transmit touch coordinate information, touch sensitivity information, a number of touch sensors of the boundary surface touch region, and boundary touch information including touch sensing data corresponding to all touch sensors positioned within the boundary touch region to the first touch IC.

Next, the second touch IC of the present disclosure may check whether the boundary touch region adjacent to the boundary surface out of an entire region of the big touch is separable when the touch is the big touch (S40).

Here, the second touch IC may acquire touch sensitivity of the entire big touch region of the second region based on the touch sensing signal, search for touch sensors whose touch sensitivity is the reference value or more based on the acquired touch sensitivity, and analyze the touch sensitivity of touch sensors positioned between the touch sensors whose touch sensitivity is the reference value or more to check whether the boundary touch region of the big touch is separable.

As an example, when the touch sensitivity of touch sensors positioned between the touch sensors whose touch sensitivity is the reference value or more gradually decreases and then increases, the second touch IC may check that the boundary touch region is separable around the touch sensor with the lowest level of touch sensitivity.

As another example, the second touch IC may input the touch sensitivity of the touch sensors positioned between the touch sensors whose touch sensitivity is the reference value or more into a pre-trained neural network model to predict a touch sensor of separation reference based on a touch sensitivity level distribution.

As still another example, when touch sensitivity of touch sensors positioned within a certain distance from touch sensors whose touch sensitivity is the reference value or more have a preset sensitivity level distribution, the second touch IC may select a touch sensor that becomes a separation reference based on the preset sensitivity level distribution and check that the boundary touch region is separable around the selected touch sensor.

In addition, the second touch IC of the present disclosure may separate the boundary touch region out of the entire region of the big touch when the boundary touch region is separable, and transmit the boundary touch information of the separated boundary touch region to the first touch IC (S50).

Here, when the boundary touch region of the big touch is separated, the second touch IC may transmit touch coordinate information, touch sensitivity information, a number of touch sensors of the separated boundary touch region, and boundary touch information including touch sensing data corresponding to all touch sensors positioned within the boundary touch region to the first touch IC.

As an example, the touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of touch sensors may include a total number of touch sensors within the touch region covered by the touch.

Next, when the boundary touch region of the big touch is not separable, the second touch IC may transmit the big touch information of the big touch excluding touch sensing data corresponding to all touch sensors positioned within the entire big touch region of the second region to the first touch IC (S60).

Here, the second touch IC may transmit big touch information including big touch coordinate information, big touch sensitivity information, and a number of big touch sensors to the first touch IC.

As an example, the big touch coordinate information may include an X end touch sensor coordinate, a Y start touch sensor coordinate, and a Y end touch sensor coordinate, the big touch sensitivity information may include a maximum sensitivity value of the touch sensor, an X coordinate touch sensor position with maximum sensitivity, and a Y coordinate touch sensor position with maximum sensitivity, and the number of big touch sensors may include a total number of touch sensors within the big touch region covered by the big touch.

In addition, when transmitting the boundary touch information of the separated boundary touch region to the first touch IC, the second touch IC may process big touch data of a remaining big touch region excluding the boundary touch region based on the touch sensing signal.

Here, when processing the big touch data of the remaining big touch region excluding the boundary touch region, the second touch IC may store the processed big touch data in the memory and transmit the stored big touch data to the first touch IC when receiving a transmission request of the big touch data from the first touch IC which is pre-selected as the master IC.

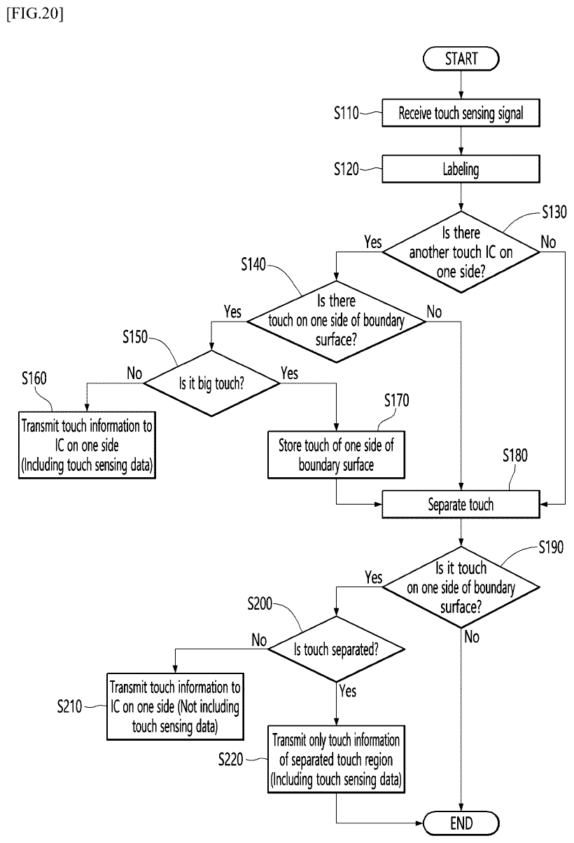

FIG. 20 is a flowchart for describing a touch sensing method of a touch sensing apparatus including a plurality of touch ICs respectively corresponding to separate regions of the touch panel.

As shown in FIG. 20, the touch IC of the present disclosure may receive touch sensing signals from the touch sensor of the touch panel (S110).

In addition, the touch IC of the present disclosure may process the received touch sensing signal to generate and label touch sensing data (S120).

Next, the touch IC of the present disclosure may check whether there is another touch IC on one side (S130).

Next, when there is another touch IC on one side, the touch IC of the present disclosure may check whether there is a touch on one-side boundary surface (S140).

In addition, when there is the touch on the one-side boundary surface, the touch IC of the present disclosure may check whether the touch is a big touch of a preset size or more (S150).

Here, when the touch is not a big touch, the touch IC of the present disclosure may transmit touch information including touch coordinate information, touch sensitivity information, a number of touch sensors of the touch region, and touch sensing data corresponding to all touch sensors positioned within the touch region to another touch IC on one side (S160).

Next, when the touch is a big touch, the touch IC of the present disclosure may store the touch on the one-side boundary surface out of the entire region of the big touch (S170) and separate the big touch (S180).

Here, the big touch separation may be finger separation when a touch means is a finger.

As an example, the touch IC of the present disclosure may acquire touch sensitivity of the entire big touch region based on the touch sensing signal, search for touch sensors whose touch sensitivity is a reference value or more based on the acquired touch sensitivity, and analyze touch sensitivity of touch sensors positioned between the touch sensors whose touch sensitivity is the reference value or more to perform the finger separation of the big touch.

Next, the touch IC of the present disclosure may check whether the touch region is the touch on the one-side boundary surface (S190) and check whether the boundary touch region is separated when the touch is the touch on the one-side boundary surface (S200).

In addition, when the boundary touch region is separated, the touch IC of the present disclosure may transmit touch coordinate information, touch sensitivity information, and a number of touch sensors of the separated boundary touch region, and boundary touch information including touch sensing data corresponding to all touch sensors positioned within the boundary touch region to another touch IC on one side (S220).

In addition, when the boundary touch region is not separated, the touch IC of the present disclosure may transmit only big touch information of a big touch excluding touch sensing data corresponding to all touch sensors positioned within an entire big touch region including the boundary touch region to another touch IC on one side (S210).

Here, the touch IC of the present disclosure may transmit big touch information including big touch coordinate information, big touch sensitivity information, and a number of big touch sensors of the big touch excluding the touch sensing data to another touch IC on one side.

That is, in the present disclosure, when the boundary surface touch is the big touch, if finger separation of the big touch is possible is possible, only touch information of a part of a separable boundary surface out of the entire region of the big touch is transmitted to the adjacent touch IC or if the finger separation of the big touch is not possible, only some of the touch information, excluding touch sensing data, out of total touch information of the big touch is transmitted to the adjacent touch IC, thereby processing the big touch efficiently and quickly by minimizing a transmission amount and a transmission time of touch information.

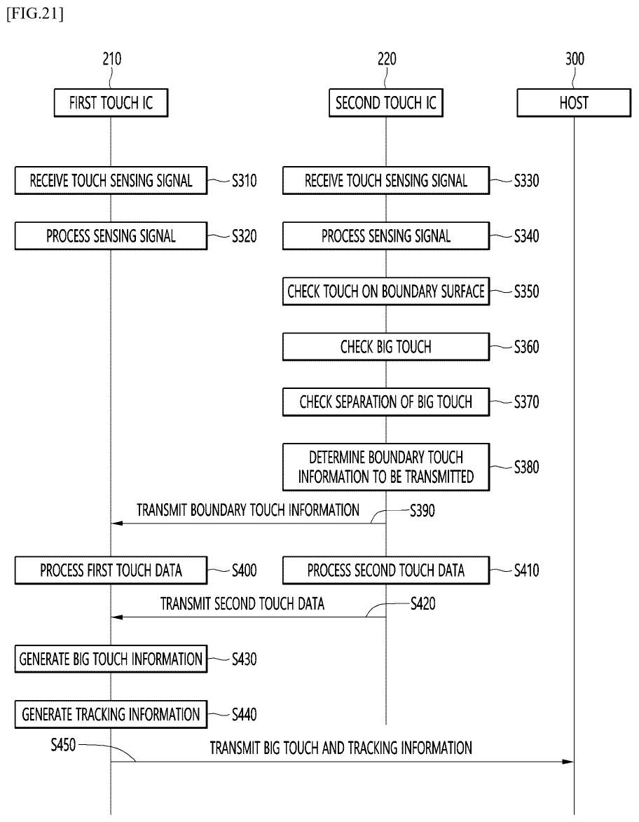

FIG. 21 is a flowchart for describing a touch information transmission process between a touch sensing apparatus including a first touch IC and a second touch IC and a host.

As shown in FIG. 21, the first touch IC 210 and the second touch IC 220 of the present disclosure may receive a touch sensing signal from a touch sensor when a big touch occurs on the touch panel.

The first touch IC 210 may receive a touch sensing signal from a touch sensor positioned in the first region of the touch panel (S310) and process the touch sensing signal (S320).

In addition, the second touch IC 220 may receive a touch sensing signal from the touch sensor positioned in the first region of the touch panel (S330) and process the touch sensing signal (S340).

Next, the second touch IC 220 may check whether there is a touch on a boundary surface adjacent to the first region out of the second region based on the touch sensing signal (S350).

Next, when there is a touch on the boundary surface, the second touch IC 220 may check whether the touch is a big touch of a preset size or more (S360).

In addition, when the touch is the big touch, the second touch IC 220 may check whether finger separation of the big touch of a big touch region is possible (S370).

Next, the second touch IC 220 may determine boundary touch information to be transmitted depending on whether the finger is separated in the big touch region (S380).

Here, when the finger separation of the big touch region is possible, the second touch IC 220 may separate a boundary touch region adjacent to a boundary surface out of an entire region of the big touch and transmit boundary touch information including touch sensing data of the separated boundary touch region to the first touch IC 210 (S390).

That is, the second touch IC 220 may transmit boundary touch information including touch sensing data corresponding to all touch sensors positioned within the boundary touch region to the first touch IC 210.

Here, the boundary touch information may include touch coordinate, touch sensitivity information, a number of touch sensors of the boundary touch, and touch sensing data of each touch sensor.

In addition, when the finger separation of the big touch region is not possible, the second touch IC 220 may transmit only big touch information not including touch sensing data to the first touch IC 210.

That is, the second touch IC 220 may transmit only big touch information excluding touch sensing data corresponding to all touch sensors positioned within the entire big touch region to the first touch IC 210.

Here, the big touch information may include big touch coordinate information, big touch sensitivity information, and a number of big touch sensors.

Next, the first touch IC 210 may process first touch data of the first region based on the touch sensing signal and process third touch data of the boundary touch region within the second region based on the boundary touch information when receiving the boundary touch information of the boundary touch region from the second touch IC 220 (S400).

Here, the first touch IC 210 may process the first touch data of the first region and simultaneously receive the boundary touch information of the boundary touch region within the second region from the second touch IC 220.

In addition, when receiving the boundary touch information from the second touch IC 220, the first touch IC 210 may process continuously the third touch data of the boundary touch region within the second region based on the boundary touch information after processing the first touch data of the first region.

In addition, the second touch IC 220 may process second touch data of a region other than the boundary touch region out of the second region (S410) and transmit the processed second touch data to the first touch IC 210 (S420).

Next, when the first touch IC 210 is selected as a master IC, the first touch IC 210 may receive the second touch data of the second region from the second touch IC 220 and generate big touch information based on the first touch data of the first region, the second touch data of the second region, and the third touch data of the boundary touch region within the second region (S430).

Here, the first touch IC 210 may check whether the first touch IC 210 has been pre-selected as the master IC after processing the first touch data of the first region and the third touch data of the boundary touch region within the second region, and the first touch IC 210 may request the second touch IC to transmit the second touch data of the second region when the first touch IC 210 is pre-selected as the master IC.

Next, the first touch IC 210 may transmit the generated big touch information to the host.

In some cases, the first touch IC 210 may generate touch tracking information based on the first touch data of the first region and the second touch data of the second region (S440) and transmit the touch tracking information together with the touch information to the host 300 (S450).

As another embodiment, the second touch IC 220 may check whether the second touch IC 220 has been pre-selected as the master IC after processing the second touch data of the second region, and the second touch IC 220 may request the first touch IC 210 to transmit of the first touch data of the first region when the second touch IC 220 is pre-selected as the master IC.

Next, when the second touch IC 220 is pre-selected as the master IC, the second touch IC 220 may receive the first touch data of the first region and fourth touch data of the boundary touch region within the first region from the first touch IC 210 and generate big touch information based on the second touch data of the second region, the first touch data of the first region, and the fourth touch data of the boundary touch region within the first region.

In addition, when generating big touch information, the second touch IC 220 may generate touch tracking information based on the first touch data of the first region and the second touch data of the second region and transmit the touch tracking information together with the big touch information to the host 300.

As such, in the present disclosure, it is possible to accurately recognize the big touch of a touch panel and process the big touch efficiently and quickly by transmitting only necessary information of a boundary touch region out of an entire region of a big touch to an adjacent touch IC when a boundary surface touch between different regions of the touch panel is the big touch.

That is, in the present disclosure, when the boundary surface touch is the big touch, if finger separation of the big touch is possible, only touch information of a part of a separable boundary surface out of the entire region of the big touch is transmitted to the adjacent touch IC or if the finger separation of the big touch is not possible, only some of the touch information excluding touch sensing data out of total touch information of the big touch is transmitted to the adjacent touch IC, thereby processing the big touch efficiently and quickly by minimizing a transmission amount and a transmission time of touch information.

The present disclosure described above may be implemented as computer-readable code on a program-recorded medium. A computer-readable media includes all types of recording devices in which data may be read by a computer system is stored. As an example of the computer-readable media, there are a hard disk drive (HDD), a solid-state disk (SSD), a silicon disk drive (SDD), ROM, RAM, CD-ROM, magnetic tape, floppy disk, optical data storage device, and the like. In addition, the computer may include a processor of an artificial intelligence device.

### INDUSTRIAL APPLICABILITY

According to the touch sensing apparatus according to the present disclosure, there is an effect that a touch sensing apparatus can accurately recognize a big touch of a touch panel and process the big touch efficiently and quickly by transmitting only necessary information of a boundary touch region out of an entire region of a big touch to an adjacent touch IC when a boundary surface touch between different regions of a touch panel is the big touch, and thus industrial applicability is remarkable.

What is claimed is:

1. A touch sensing apparatus configured to process a touch on a touch panel, the touch sensing apparatus comprising:
a first touch IC configured to generate first touch data corresponding to a first region of the touch panel, and
a second touch IC configured to generate second touch data corresponding to a second region adjacent to the first region of the touch panel,
wherein the second touch IC checks whether there is a touch on a boundary surface of the second region adjacent to the first region based on a touch sensing signal when the touch sensing signal is input from a touch sensor positioned in the second region of the touch panel, checks whether the touch is a big touch of a preset size or more when there is the touch on the boundary surface, separates a boundary touch region adjacent to the boundary surface out of an entire region of the big touch when the touch is a big touch, and transmits boundary touch information of the separated boundary touch region to the first touch IC.

2. The touch sensing apparatus of claim 1, wherein the first touch IC processes the first touch data of the first region based on the touch sensing signal when a touch sensing signal is input from a touch sensor positioned in the first region of the touch panel and
processes third touch data of the boundary touch region within the second region based on the boundary touch information when the boundary touch information of the boundary touch region is received from the second touch IC.

3. The touch sensing apparatus of claim 2, wherein the first touch IC processes the first touch data of the first region and simultaneously receives the boundary touch information of the boundary touch region within the second region from the second touch IC.

4. The touch sensing apparatus of claim 1, wherein the first touch IC receives the second touch data of the second region from the second touch IC when selected as a master IC,
generates big touch information based on the first touch data of the first region, the second touch data of the second region, and the third touch data of the boundary touch region within the second region, and
transmits the generated big touch information to a host.

5. The touch sensing apparatus of claim 4, wherein, when generating the big touch information, the first touch IC generates touch tracking information based on the first touch data of the first region, the second touch data of the second region, and the third touch data of the boundary touch region within the second region and transmits the touch tracking information together with the big touch information to the host.

6. The touch sensing apparatus of claim 2, wherein the first touch IC receives boundary touch information including touch coordinate information, touch sensitivity information, and a number of touch sensors of the boundary touch region from the second touch IC.

7. The touch sensing apparatus of claim 1, wherein the second touch IC checks whether the touch is continuous from a touch sensor arranged in a first column of the second region at the boundary surface to a touch sensor arranged in an Nth reference column when checking whether the touch is the big touch of the preset size or more, and recognizes the touch as the big touch of the preset size or more when the touch is continuous.

8. The touch sensing apparatus of claim 7, wherein, when the touch is continuous from the touch sensor arranged in the first column of the second region to the touch sensor arranged in an N−1th column at the boundary surface, the second touch IC recognizes the touch as a normal touch smaller than the big touch.

9. The touch sensing apparatus of claim 8, wherein when recognizing the touch as the normal touch, the second touch IC transmits the boundary touch information of the boundary touch region adjacent to the boundary surface to the first touch IC.

10. The touch sensing apparatus of claim 9, wherein when transmitting the boundary touch information, the second touch IC transmits boundary touch information including touch coordinate information of the boundary touch region, touch sensitivity information, the number of touch sensors, and touch sensing data corresponding to all touch sensors positioned within the boundary touch region to the first touch IC.

11. The touch sensing apparatus of claim 1, wherein, when separating a boundary touch region adjacent to the boundary surface, the second touch IC checks whether the boundary touch region adjacent to the boundary surface out of the entire region of the big touch is separable, and when the boundary touch region is separable, the second touch IC separates the boundary touch region of the big touch and transmits the boundary touch information of the separated boundary touch region to the first touch IC.

12. The touch sensing apparatus of claim 11, wherein, when checking whether the boundary touch region of the big touch is separable, the second touch IC acquires touch sensitivity of the entire big touch region of the second region based on the touch sensing signal, searches for touch sensors whose touch sensitivity is a reference value or more based on the acquired touch sensitivity, and analyzes touch sensitivity of touch sensors positioned between the touch sensors whose touch sensitivity is the reference value or more to check whether the boundary touch region of the big touch is separable.

13. The touch sensing apparatus of claim 11, wherein, when the boundary touch region of the big touch is separated, the second touch IC transmits boundary touch information including touch sensing data corresponding to touch coordinate information, touch sensitivity information, the number of touch sensors, and all touch sensors corresponding to the boundary touch region of the separated boundary touch region to the first touch IC.

14. The touch sensing apparatus of claim 11, wherein, when the boundary touch region of the big touch is not separable, the second touch IC transmits the big touch information of the big touch excluding touch sensing data corresponding to all touch sensors positioned within the entire big touch region of the second region to the first touch IC.

15. A touch sensing apparatus configured to process a touch of a touch panel, the touch sensing apparatus includes:
one or more read-out integrated circuits (ROICs) configured to receive a touch sensing signal from a first region of the touch panel and a second region adjacent to the first region; and
a micro controller unit (MCU) configured to determine whether there is a big touch based on the touch sensing signal,
wherein the MCU checks whether there is a touch on the boundary surface of the second region adjacent to the first region based on the touch sensing signal when the touch sensing signal is input from a touch sensor positioned in the second region of the touch panel, checks whether the touch is a big touch of a preset size or more when there is a touch on the boundary surface, separates a boundary touch region adjacent to the boundary surface out of an entire region of the big touch when the touch is a big touch, and stores boundary touch information of the separated boundary touch region.

16. The touch sensing apparatus of claim 15, wherein the MCU processes first touch data of the first region of the touch panel, second touch data of the second region, and third touch data of the boundary touch region within the second region based on the touch sensing signal, generates big touch information based on the first, second, and third touch data, and transmits the generated big touch information to a host.

17. The touch sensing apparatus of claim 16, wherein, when generating the big touch information, the MCU generates touch tracking information based on the first touch data of the first region, the second touch data of the second region, and the third touch data of the boundary touch region within the second region and transmits the touch tracking information together with the big touch information to the host.

18. A touch IC connected to touch sensors corresponding to one region of a touch panel, the touch IC comprising:
a communication unit connected to communication with another touch IC connected to touch sensors corresponding to another region of the touch panel; and
a touch data processing unit configured to generate touch data for the one region of the touch panel,
wherein the touch data processing unit checks whether there is a touch on a boundary surface of the one region adjacent to the another region based on a touch sensing signal when the touch sensing signal is input from the touch sensor positioned in the one region of the touch panel, checks whether the touch is a big touch larger than a preset size when there is the touch on the boundary surface, separates a boundary touch region adjacent to the boundary surface out of an entire region of the big touch when the touch is the big touch, and transmits boundary touch information of the separated boundary touch region to the another touch IC.

19. The touch IC of claim 18, further comprising
a touch signal detection unit configured to detect the touch sensing signal from the touch sensor;
a signal processing unit configured to process the detected touch sensing signal to generate touch sensing data; and
a memory configured to store the touch sensing data.

20. A touch sensing method of a touch sensing apparatus including a first touch IC configured to generate first touch data corresponding to a first region of a touch panel and a second touch IC configured to generate second touch data corresponding to a second region of the touch panel adjacent to the first region, the touch sensing method comprising:
checking, by the second touch IC, whether there is a touch on a boundary surface of the second region adjacent to the first region based on a touch sensing signal when the touch sensing signal is input from a touch sensor positioned in the second region of the touch panel;
checking, by the second touch IC, whether the touch is a big touch larger than a preset size when there is the touch on the boundary surface;
separating, by the second touch IC, a boundary touch region adjacent to the boundary surface out of an entire region of the big touch when the touch is the big touch; and
transmitting, by the second touch IC, boundary touch information of the separated boundary touch region to the first touch IC.
